(19) United States
(12) Patent Application Publication
(10) Pub. No.: US 2026/0233170 A1
(43) Pub. Date: Aug. 13, 2026

(54) SEPARATION METHODS AND SYSTEMS

(71) Applicant: ALTR FLTR INC., Cave Creek, AZ (US)

(72) Inventors: Richard Schatzberger, Cave Creek, AZ (US); Lyderic Bocquet, Paris (FR); Alessandro Siria, Paris (FR); Kathryn Maurine Orr, Phoenix, AZ (US); Jessica Nicholls, Chandler, AZ (US)

(21) Appl. No.: 19/154,857

(22) PCT Filed: Feb. 8, 2024
(86) PCT No.: PCT/US2024/015022

§ 371 Date: Aug. 8, 2025

Related U.S. Application Data
(60) Provisional application No. 63/483,985, filed on Feb. 9, 2023.

(51) Int. Cl. B01D 67/00; B01D 61/00; B01D 71/02

(52) U.S. Cl. CPC B01D 67/0088; B01D 61/002; B01D 71/0211; B01D 2311/02; B01D 2323/21823; B01D 2323/46

(57) ABSTRACT

Various systems and processes are directed to separating organic compounds using semipermeable materials, such as nanoporous materials. In various implementations, the nanoporous material includes a membrane, a substrate, or a combination of membrane and substrate. In some implementations, the nanoporous material is a liquid infused material comprising wetting fluid intercalated into the pores of the material. The nanoporous material can be wetted with one or more first organic compounds such that the nanoporous material preferentially allows one or more second organic compounds to permeate the nanoporous material to the complete or substantial exclusion of other compounds. In some implementations, the nanoporous material is wetted with an alcohol such that the nanoporous material preferentially allows ethanol to permeate the nanoporous material to the complete or substantial exclusion of other compounds, such as water or other compounds or mixtures. In some implementations, the selective ethanol permeation of the nanoporous material may occur even where the other compounds have smaller molecules than ethanol.

### FIELD

The present disclosure relates to semipermeable materials and removal of an organic compound.

### BACKGROUND

Separation technologies that use a selective barrier to remove organic compounds can be useful in such diverse fields as food and beverage processing, chemical and pharmaceutical manufacturing, water treatment, fuel (e.g., oil and gas) production, and medical applications (e.g., blood treatments such as dialysis). The selective barrier can be a semipermeable membrane that will allow some molecules to pass through while blocking the passage of other molecules. Features of semipermeable membranes can be selected based on the molecules to be removed from a starting material. Semipermeable membranes can be fabricated from biological or synthetic materials and can have a pore size that is selected based upon the size of the molecule to be removed. In some applications, it can be desirous to remove alcohol from various fluids, including beverages, blood, fuel, and the like.

For example, there is a growing interest around the world for low alcohol and non-alcoholic adult beverages. While low alcohol and non-alcoholic adult beverages have been around for many years, available low alcohol and non-alcoholic adult beverages have yet to provide satisfactory flavor profiles that can mimic or substitute for traditional alcoholic beverages.

For example, some methods of making low alcohol or non-alcoholic beverages include suppressing alcoholic fermentation in the production process, to thereby reduce the content of alcohol produced by the fermentation. Other methods include heating an alcoholic beverage to 175 degrees Fahrenheit for 15 to 20 minutes, which causes the ethanol in the beverage to evaporate. However, these methods generally result in low alcohol or non-alcoholic beverages that do not taste like their alcoholic counterparts. In many instances, the resulting low alcohol or non-alcoholic beverages either have very little flavor or taste so bad that they are undrinkable.

Accordingly, there is a need to produce low alcohol or non-alcoholic adult beverages that taste like their alcoholic counterparts and can mimic or substitute for traditional alcoholic beverages.

### BRIEF SUMMARY

The present disclosure is directed to systems and processes for separating organic compounds using semipermeable material. In various implementations, the semipermeable material comprises a membrane, a substrate, or a combination of membrane and substrate. In some implementations, a semipermeable material can comprise one or more membranes and/or substrates. In various implementations, the semipermeable material can be wetted with one or more first organic compounds such that the semipermeable material preferentially allows one or more second organic compounds to permeate the semipermeable material to the complete or substantial exclusion of one or more other compounds. In some implementations, the semipermeable material is a liquid infused material.

In various implementations, the semipermeable material comprises nanoporous material. In some implementations, a nanoporous material comprises a membrane, a substrate, or a combination of membrane and substrate. In some implementations, a nanoporous material can comprise one or more membranes and/or substrates. In various implementations, the nanoporous material can be wetted with one or more first organic compounds such that the nanoporous material preferentially allows one or more second organic compounds to permeate the nanoporous material to the complete or substantial exclusion of one or more other compounds. In some implementations, the nanoporous material is a liquid infused material. Nanoporous material will be used to describe various aspects of methods and systems; however, it is understood that semipermeable materials described herein can also be used in accordance with separation methods and systems.

In some implementations, the nanoporous material is wetted with a first organic compound comprising an alcohol such that the nanoporous material preferentially allows ethanol to permeate through the nanopores to the complete or substantial exclusion of other compounds, such as water or other compounds or mixtures. In some implementations, the nanoporous material is wetted with an alcohol, such that the nanoporous material preferentially allows ethanol to permeate through the nanopores to the complete or substantial exclusion of other compounds, such as water or other compounds or mixtures. In some implementations, the selective ethanol permeation of the nanoporous material may occur even where the other compounds (such as compounds that may impart flavor characteristics to a beverage) may have smaller sizes than ethanol and these other compounds should have more easily passed through the nanoporous material over ethanol molecules.

Various implementations of the systems and methods may include separating an organic compound from a fluid, the method including one or more of the following: wetting a nanoporous material with a wetting fluid comprising a first compound; moving a second fluid across a first side of the nanoporous material for a predetermined quantity of time at a first predetermined rate, wherein the second fluid is in contact with the first side of the nanoporous material and wherein the second fluid comprises at least one second compound; moving a third fluid across a second side of the nanoporous material for the predetermined quantity of time at a second predetermined rate; transferring the at least one second compound from the second fluid to the third fluid through the nanoporous material; and recovering the second fluid with at least a portion of the at least one second compound removed from the second fluid.

In some implementations, methods can comprise recovering the third fluid. In various implementations, the recovered third fluid can be used as a wetting fluid for wetting a nanoporous material for separating an organic compound from a fluid.

In various implementations, the semipermeable material comprises a membrane, a substrate, or a membrane-substrate combination. In some implementations, the semipermeable material comprises a carbon-based membrane, a molybdenum-based membrane, or a carbon-based foam. In some implementations, the carbon-based membrane comprises graphene-based membrane. In some implementations, molybdenum-based membrane comprises molybdenum disulfide. In various implementations, the semipermeable material comprises a substrate, such as a substrate composed of polymeric, inorganic, and/or metallic material. In various implementations, the semipermeable substrate can be wetted with one or more first organic compounds such that the substrate preferentially allows one or more second organic compounds to permeate the substrate to the complete or substantial exclusion of one or more other compounds.

In some implementations, the wetting fluid substantially comprises an alcohol. In various implementations, the wetting fluid comprises 20 vol-% or greater of an alcohol. In some implementations, the wetting fluid is selected from methanol, ethanol, 1-propanol, 2-propanol, 1-butanol, 2-butanol, 2-methyl-1-propanol (isobutyl alcohol), 2-methyl-2-propanol, 1-pentanol, 3-methyl-1-butanol (isopentyl alcohol), 2,2-dimethyl-1-propanol (neopentyl alcohol), cyclopentanol, 1-hexanol, cyclohexanol, 1-heptanol, 2-heptanol, 1-octanol, 1-nonanol, 1-decanol, phenylmethanol, diphenylmethanol (diphenylcarbinol), and triphenylmethanol (triphenylmethanol), or a combination of any two or more of these. In some implementations, the wetting fluid comprises an alcohol having a kinematic viscosity in a range of 0.55 to 15 cP at standard conditions. In some implementations, the wetting fluid comprises heptanol, butanol, ethanol, or a combination of any two or more of these. In some implementations, the first organic compound comprises substantially heptanol.

In some implementations, the at least one second organic compound comprises ethanol. In various aspects, when the at least one second organic compound comprises ethanol, transferring the ethanol from the second fluid to the third fluid through the membrane preferentially permits the ethanol to transfer to the third fluid while substantially excluding water from transferring to the third fluid through the membrane.

In some implementations, wetting the semipermeable material comprises exposing the semipermeable membrane and/or substrate to the wetting fluid under conditions that allow the wetting fluid to enter into pores of the membrane or substrate. Various methods and systems for wetting will be discussed with respect to wetting membranes; however, it will be understood that the methods can also apply to wetting of substrates. In some implementations, the semipermeable material can be exposed to wetting fluid one or more times (e.g., in one or more exposure steps).

In some implementations, wetting the membrane comprises exposing the membrane to the wetting fluid under conditions that allow the wetting fluid to saturate the membrane. In some implementations, wetting the membrane can comprise one or more of the following: dipping or soaking the membrane in the wetting fluid, exposing the membrane to the wetting fluid under gravity and/or pressure, applying droplets of the wetting fluid onto the membrane (e.g., misting or spraying the wetting fluid onto the membrane), evaporative deposition of the wetting fluid on the membrane, and the like. Optionally, wetting the membrane can include agitating the membrane during application of the wetting fluid. In some aspects, agitation can assist the wetting fluid to permeate into the pores of the membrane. In some implementations, the membrane can be agitated using such methods as sonication or mechanical vibration.

In some implementations, wetting the membrane comprises evaporative deposition of the wetting fluid on the membrane. In some implementations, evaporative deposition can involve maintaining the membrane in the presence of the wetting fluid within a closed system, whereby wetting fluid present in a gaseous phase may interact with the membrane to alter its properties. In some implementations, evaporative deposition of the wetting fluid can involve heating the wetting fluid in the presence of the membrane in a vacuum. In some implementations, the wetting fluid can be heated to a temperature at which point it transitions from a liquid phase to gas phase (vaporizes). Because the membrane and wetting fluid are contained within a vacuum, the wetting fluid will transition to the gas phase at a temperature below its boiling point, and vapor particles are able to travel to the membrane, where they can then present at a high enough concentration at the surface to change the characteristics of membrane. The heated wetting fluid and membrane are maintained in vacuum for a suitable period of time, for example, an hour. This completes one evaporative deposition cycle.

If additional wetting fluid is desired, more than one evaporative deposition cycle can be performed, until the desired wetting effects have been achieved for the membrane. Optionally, the membrane can be maintained at a temperature that is below room temperature, such as below 25° C., or below 22° C. or below 20° C. or below 15° C. or below 10° C. or below 5° C. or below 0° C., or in a range of about 5° C. to about 25° C. In some implementations, wetting the membrane further includes misting at least one layer of the wetting fluid on the membrane.

In some implementations, a pressure is applied to the second fluid on the first side of the membrane. In some implementations, a pressure is applied to the second fluid on the first side of the membrane with a gas. In some implementations, the gas is substantially an inert gas. In some implementations, the pressure is 30 bar or less, or 20 bar or less, or 10 bar or less, or 5 bar or less. In some implementations, the third fluid comprises water.

In some implementations, moving the second fluid across the first side of the membrane for the predetermined quantity of time at the first predetermined rate further comprises moving the second fluid tangentially across the first side of the membrane. In some implementations, moving the third fluid across the second side of the membrane for the predetermined quantity of time at the second predetermined rate further includes moving the third fluid tangentially across the second side of the membrane. In some implementations, the second fluid is moved across the first side of the membrane in a first direction and the third fluid is moved across the second side of the membrane in a second direction, wherein the first direction and the second direction are the same direction. In some implementations, the second fluid is moved across the first side of the membrane in a first direction and the third fluid is moved across the second side of the membrane in a second direction, wherein the first direction and the second direction are different directions. In some implementations, the first direction and the second direction are opposite directions. In some implementations, the third fluid is water and the water is moved across the second side of the membrane during the predetermined quantity of time. In some implementations, the second predetermined rate is faster than the first predetermined rate, for example, the second predetermined rate can be in a range of 1 to 5 times faster than the first predetermined rate. In some implementations, the first predetermined rate is faster than the second predetermined rate, for example, the first predetermined rate can be in a range of 1 to 5 times faster than the second predetermined rate. The relative difference in rate of movement of the fluids can be determined based upon a variety of factors, such as relative volume of first fluid and second fluid, desired rate of separation, the size of the organic compound to be separated from the fluid, and the like.

In some implementations, the membrane comprises a carbon-based membrane, a molybdenum-based membrane, or a carbon-based foam. In some implementations, the membrane further includes a substrate. In various implementations, the nanoporous material comprises substrate alone (i.e., without membrane).

In some implementations, transferring the second organic compound from the second fluid to the third fluid through the membrane is accomplished without the addition of an external substance (such as glucose) to the third fluid. In some implementations, transferring the second organic compound from the second fluid to the third fluid through the membrane is accomplished without applying pressure to the second fluid, the third fluid, or both the second and third fluid. In some implementations, the second organic compound is transferred from the second fluid to the third fluid through the membrane using osmosis.

When a substrate is utilized, the second organic compound can be transferred from the second fluid to the third fluid through the substrate without the addition of an external substance (such as glucose) to the third fluid. In some implementations, the second compound can be transferred from the second fluid to the third fluid through the substrate without applying pressure to the second fluid, the third fluid, or both the second and third fluid. In some implementations, the second organic compound is transferred from the second fluid to the third fluid through the substrate using osmosis.

In various implementations, a pre-wetted nanoporous material enclosed in packaging is provided, the pre-wetted nanoporous material comprising: graphene oxide, one or more substrates, or a combination of graphene oxide and one or more substrates; and wetting fluid, wherein the wetting fluid is contained within the graphene oxide membrane, one or more substrates, or graphene oxide and one or more substrates.

In some implementations, the pre-wetted nanoporous material can comprise a graphine oxide membrane.

In various implementations, a pre-wetted nanoporous material enclosed in packaging is provided, the pre-wetted nanoporous material comprising: molybdenum disulfide, one or more substrates, or a combination of molybdenum disulfide and one or more substrates; and wetting fluid, wherein the wetting fluid is contained within the molybdenum disulfide membrane, one or more substrates, or molybdenum disulfide and one or more substrates.

In some implementations, the pre-wetted nanoporous material can comprise a molybdenum disulfide membrane.

In various implementations, a pre-wetted nanoporous material enclosed in packaging is provided, the pre-wetted nanoporous material comprising: carbon-based foam, one or more substrates, or a combination of carbon-based foam and one or more substrates; and wetting fluid, wherein the wetting fluid is contained within the carbon-based foam, one or more substrates, or carbon-based foam and one or more substrates.

In some implementations, the pre-wetted nanoporous material comprises a substrate. In various implementations, wetting fluid is contained within the substrate. In some implementations, the one or more substrates comprise one or more polymer layers or sheets. In some implementations, the one or more polymer layers or sheets are independently selected from polyamide, polytetrafluoroethylene, polyethersulphone, polycarbonate, polyvinylidene fluoride, polysulfone, polyvinyl chloride, cellulose acetate, nitrocellulose, polyimide, polyacrylonitrile, polypropylene, polyethylene, polyvinyl alcohol, poly(4-methyl-1-pentene), poly(dimethyl siloxane), poly(arylene ether ketone), poly(ether imide), polyethersulfone amide, or combinations or blends of any two or more of these. In various implementations, the one or more polymer layers or sheets can comprise surface architecture. In some implementations, the one or more substrates can comprise metallic mesh, aluminum, alumina, copper, active carbon, or a combination of any two or more of these.

In some implementations, the wetting fluid can comprise 20 vol-% or greater of an alcohol. In various implementations, the wetting fluid is selected from methanol, 1-propanol, 2-propanol, 1-butanol, 2-butanol, 2-methyl-1-propanol (isobutyl alcohol), 2-methyl-2-propanol, 1-pentanol, 3-methyl-1-butanol (isopentyl alcohol), 2,2-dimethyl-1-propanol (neopentyl alcohol), cyclopentanol, 1-hexanol, cyclohexanol, 1-heptanol, 2-heptanol, 1-octanol, 1-nonanol, 1-decanol, phenylmethanol, diphenylmethanol (diphenylcarbinol), and triphenylmethanol (triphenylmethanol), or a combination of any two or more of these. In some implementations, the wetting fluid can comprise an alcohol having a kinematic viscosity in a range of 0.55 to 15 cP at standard conditions. In some implementations, the wetting fluid comprises heptanol in an amount of 20 vol-% or more.

In various implementations, the pre-wetted nanoporous material can be enclosed in packaging that is impermeable to gas and water vapor. In various implementations, the pre-wetted nanoporous material can be enclosed in opaque material, for example, when the nanoporous material is susceptible to light-induced alterations. In some implementations, packaging can comprise aluminum foil. In various implementations, packaging can comprise multiple layers of foil and plastics. In various implementations, packaging can comprise ethylene/vinyl alcohol, polyamide, polyvinyl alcohol, polyvinylidene chloride, metallized aluminum, silicon oxide, aluminum oxide, or a combination of any two or more of these. In various implementations, packing for the pre-wetted nanoporous material can comprise a pouch, vacuum-bag, or tray.

In various implementations, pre-wetted nanoporous material enclosed in packaging can further comprise an amount of free wetting fluid within the packaging.

In some implementations, pre-wetted nanoporous material enclosed in packaging can comprise a structure: substrate/membrane/substrate. For example, pre-wetted nanoporous material can be provided in a multilayer format, wherein layers of substrate and membrane can be provided. In some implementations, each membrane can be independently selected from graphene-based membrane, molybdenum-based membrane, or carbon-based foam. In some implementations, each substrate can be independently selected from polyamide, polytetrafluoroethylene, polyethersulphone, polycarbonate, polyvinylidene fluoride, polysulfone, polyvinyl chloride, cellulose acetate, nitrocellulose, polyimide, polyacrylonitrile, polypropylene, polyethylene, polyvinyl alcohol, poly(4-methyl-1-pentene), poly(dimethyl siloxane), poly(arylene ether ketone), poly(ether imide), polyethersulfone amide, or combinations or blends of any two or more of these. In some implementations, pre-wetted nanoporous material can comprise a multilayer structure: Nylon/graphine oxide/Nylon.

In some implementations, pre-wetted nanoporous material enclosed in packaging can be provided with a protective layer. Suitable protective layers can comprise polymer films, such as any of the polymers described herein. In some aspects, a protective polymer film can comprise Nylon or polycarbonate.

It should be appreciated that in some implementations, the various methods and apparatuses discussed herein, when applied to alcoholic beverages, enable dealcoholization of the beverages with minimal changes on the physiochemical properties of the beverages. As used herein, “dealcoholization” involves removal of ethanol from alcoholic beverages having an initial alcohol content, to provide a beverage having a final alcohol content that is lower than the initial alcohol content. For example, alcoholic beverages produced by fermentation (such as beer, cider, wine, mead, and the like) typically have an initial alcohol content of less than 15% (v/v), while alcoholic beverages produced by distillation (such as vodka, gin, tequila, whiskey, mezcal, brandy, and similar spirits) typically have an initial alcohol content of at least 20% (v/v), or about 20% to about 40% (v/v). In some implementations, the methods and apparatuses discussed herein can enable removal of ethanol from alcoholic beverages to provide beverages that have a reduced level of alcohol (as compared to their initial alcohol content), while maintaining the organoleptic and nutritional values of the original beverage. In other words, in some implementations, the novel methods and apparatuses discussed herein can produce a reduced alcohol beverage that tastes the same or very similar to its original, full alcoholic counterpart and can mimic or substitute for traditional alcoholic beverages. In some implementations, dealcoholization can remove a desired amount of ethanol from an alcoholic beverage, for example, a relatively small amount of ethanol (such as about 0.5 to about 5%), a moderate amount, or even substantially all of the ethanol in the alcoholic beverage.

In some implementations, the methods and apparatuses discussed herein enable ethanol or ethyl alcohol to be substantially removed from an alcoholic beverage while substantially preventing other compounds from being removed from the alcoholic beverage. The resulting beverage can either contain low alcohol or substantially no alcohol, while retaining many or most of the compounds that give the original alcoholic beverage its signature taste. For example, if the methods and apparatuses discussed herein are applied to a brewed alcoholic beverage (e.g., a stout beer) to produce an altered stout beer, the altered stout beer continues to maintain the taste characteristics of the unaltered stout beer, while the altered stout beer has low or substantially no alcohol. As another example, if the methods and apparatuses discussed herein are applied to a distilled spirit like gin, the altered gin continues to maintain the taste and aroma characteristics of the unaltered gin, while the altered gin has low or substantially no alcohol. In other words, in some implementations, the novel methods and apparatuses discussed herein can produce a low alcohol or non-alcoholic beverage that tastes the same or very similar to its alcoholic counterpart and can mimic or substitute for traditional alcoholic beverages. As used herein, low alcohol beverages can contain 2.5% or less alcohol by volume (ABV), or 2% or less ABV, or 1% or less ABV, or 0.5% or less ABV.

### BRIEF DESCRIPTION OF THE DRAWINGS

FIG. 1A shows a close-up schematic diagram of some layers of graphene oxide in accordance with some implementations.

FIG. 1B shows an X-ray diffractogram of a membrane of graphene oxide in accordance with some implementations.

FIG. 2A shows a process diagram illustrating a method of separating one or more compounds from a fluid in accordance with some implementations.

FIG. 2B shows a process diagram illustrating a method of separating one or more compounds from a fluid in accordance with some implementations.

FIG. 3 shows an X-Ray diffractogram and profilometry of a membrane formed by slot-die coating in accordance with some implementations.

FIG. 4A shows a schematic diagram of alternating layers of graphene oxide and substrate in accordance with some implementations.

FIG. 4B shows a schematic diagram of alternating layers of graphene oxide and substrate in accordance with some implementations.

FIG. 4C shows a schematic diagram of alternating layers of graphene oxide and substrate in accordance with some implementations.

FIG. 5A shows a cutaway schematic diagram of a membrane separating fluid reservoirs for filtering one or more compounds from a fluid in accordance with some implementations.

FIG. 5B shows a cutaway schematic diagram of a membrane separating fluid reservoirs for filtering one or more compounds from a fluid in accordance with some implementations.

FIG. 6 shows a cutaway schematic diagram of a configuration of fluid reservoirs for separating one or more compounds from a fluid in accordance with some implementations.

FIG. 7 shows ethanol concentration as a function of time when a graphene oxide membrane is prepared by vapor wetting and spray wetting in accordance with some implementations.

FIG. 8 shows ethanol concentration as a function of time when an ethanol-containing fluid is processed through one method of separating ethanol in accordance with some implementations.

FIG. 9 shows ethanol concentration as a function of time when an ethanol-containing fluid is processed through one method of separating ethanol utilizing a membrane including substrate prepared in accordance with some implementations.

FIG. 10 shows dealcoholization performance of semipermeable membranes in accordance with some implementations.

FIG. 11 shows dealcoholization performance of semipermeable membranes in accordance with some implementations.

FIGS. 12A-12C show dealcoholization performance of semipermeable membranes in accordance with some implementations.

FIG. 13 shows dealcoholization performance of various semipermeable membranes in accordance with some implementations.

FIG. 14 shows dealcoholization performance of various microporous substrates in accordance with some implementations.

### DETAILED DESCRIPTION

Various implementations of the concepts disclosed herein relate to processes and systems to remove or separate compounds from fluids. In the context of this application, “separate” can be understood to mean to reduce the amount of a compound from a fluid, such that the final product or fluid has a lower amount of the compound as compared to the initial, starting fluid. In some implementations, the compound that is separated from a fluid can be partially, substantially, or even entirely removed from the fluid.

In some implementations, processes and systems to separate organic compounds from fluids are described. In some aspects, the removal or separation of organic compounds from a fluid includes removing or separating ethanol from a fluid, such as an alcoholic beverage (e.g., an alcoholic beverage produced through fermentation, brewing, distilling, and the like). In some implementations, the alcoholic beverage may include beer, wine, or liquor. In some implementations, the ethanol can be substantially or even entirely removed from an alcoholic beverage. In some implementations, the ethanol can be partially removed from an alcoholic beverage. In some implementations, when ethanol is separated from the fluid, only ethanol is separated. In some implementations, when ethanol is separated from the fluid, ethanol as well as one or more additional compounds or products are also separated with the ethanol. In some implementations, an additional compound or product can be any chemical species. In some implementations, an additional compound or product can be any inorganic or organic molecule.

Dealcoholization of alcoholic beverages will be utilized to describe certain concepts, as these applications are useful to highlight features and advantages. However, it will be readily apparent that methods and apparatuses described herein can be used to remove other organic compounds from liquids in such fields as food and beverage processing, chemical and pharmaceutical manufacturing, water treatment, fuel (e.g., oil and gas) production, and medical applications (e.g., blood treatments such as dialysis). In some implementations, certain methods and apparatuses can be used in clarification of liquids (such as juices), or in refinement of liquids (such as fuels).

In some implementations, performance of separation systems and methods can be assessed by observing the selectivity (which refers to the semipermeable material's ability to permit ethanol transport while substantially or completely preventing transport of other compounds such as water), and dealcoholization rate.

In some aspects, evaluation of a membrane's selectivity can involve the use of two selectivity and performance indicators, denoted as R and R*. The R selectivity indicator can represent the ratio of the alcohol content variation (expressed as %) to the volumetric variation (expressed as %) for a given separation process:

$$R = \frac{Alcohol content variation ( \% )}{Volumetric variation ( \% )}$$

The R selectivity indicator can serve as a valuable tool to scrutinize the underlying mechanisms responsible for changes in alcohol content and volumetric alterations. This value can help discern whether these changes stem from genuine dealcoholization, dilution of the fee solution by the waste compartment, or if the membrane permits the passage of both water and alcohol.

In cases where R>1, this can indicate a significant change in alcohol content with minimal volumetric adjustments, corresponding to the dilution of the feed solution with the waste solution (water). Conversely, a situation with a substantial volumetric change in the feed solution accompanied by a minor variation in alcohol content would characterize a non-selective membrane, with R<1. The target value of R=1 signifies an ethanol-selective membrane.

In order to facilitate the comparison of performance between membranes that exhibit minor dilution and those presenting slight competitive passage of both water and ethanol, another performance comparison factor, R*, was developed.

$${R}^{*} = \frac{1}{2} ( R + \frac{1}{R} )$$

The R* performance metric is anticipated to approach a value of 1 for highly ethanol-selective membranes. In various aspects, a desirable membrane performance would involve a high dealcoholization rate, R approaching 1, and R* approaching 1.

In some implementations, the separation process favors one organic compound over an inorganic compound despite the organic compound comprising molecules that are larger than the inorganic compound. In some implementations, the organic compound includes ethanol and the inorganic compound is substantially water.

In some implementations, the separation or removal of organic compounds from fluids includes using semipermeable material. In the context of this application, “semipermeable” can be understood to mean a material that allows some compounds to pass through (permeate), while substantially preventing other compounds from passing through.

In some implementations, the separation of organic compounds from fluids includes using a nanoporous material. Generally, a nanoporous material can comprise a material having an average pore size of about 1000 nm or smaller, or about 900 nm or smaller, or about 800 nm or smaller, or about 700 nm or smaller, or about 600 nm or smaller, or about 500 nm or smaller, or about 400 nm or smaller, or about 300 nm or smaller, or about 200 nm or smaller, or about 100 nm or smaller. Nanoporous materials will be utilized to describe certain concepts, as these applications are useful to highlight features and advantages. However, it will be readily apparent that the pore size of a material can be selected to provide a molecular weight cutoff that will allow selective removal of desired organic materials from a starting fluid. Therefore, in some implementations, materials having pore size other than nanoporous can be utilized. In some implementations, the separation or removal of organic compounds from fluids includes using microporous materials.

In accordance with some implementations, separation methods do not include a step of adding external substances to the third fluid, such as osmotic agents including sugar (e.g., glucose) and/or salt (e.g., sodium chloride). In various implementations, separation methods do not include a step of applying pressure to the system, such as applying pressure to the second fluid, applying pressure to the third fluid, or applying pressure to the second fluid and the third fluid. In some implementations, the separation methods may include a step of applying some external pressure to the system, for example 30 bar or less, or 25 bar or less, or 20 bar or less, or 15 bar or less, or 10 bar or less, or 5 bar or less.

In accordance with various implementations, the nanoporous material is first wetted with a wetting fluid in a manner such that the nanoporous material becomes saturated with the wetting fluid. In some implementations, this saturation can persist over time even as one or more compounds are passed through the nanoporous material. In some implementations, at least a portion of the wetting fluid is retained in the nanoporous material because the wetting fluid condenses within the interpores (or nanopores) of the nanoporous material.

As discussed herein, nanoporous material can comprise one or more membranes (such as carbon-based membranes, molybendum-based membranes, and/or carbon-based foams), one or more substrates (such as polymeric or metallic substrates), or a combination of these. The particular number and arrangement of membrane layers and substrate layers can be selected based upon such factors as the organic compound to be removed, the starting material, the desired amount of organic compound to be removed, volume of the starting material, volume of fluid to be processed, rate of organic compound removal, and the like.

In some implementations, the nanoporous material comprises a membrane. In some implementations, the nanoporous material comprises a membrane combined with one or more other materials. In some implementations, the membrane may include one or more layers of graphene having a nanoporous structure. In some implementations, the membrane may include one or more layers of graphene oxide having a nanoporous structure. In some implementations, the nanoporous material can include one or more layers of molybdenum disulfide. In some implementations, the one or more other materials may include one or more layers of a substrate. In some implementations, the substrate may comprise a polymer (organic or inorganic), or a metallic material. In some implementations, the one or more other materials may include one or more layers of an aerogel with a porous structure, which can provide structural support and/or create a mixing action near the surface of the membrane while fluids flow across the surface of the membrane. In various implementations, the nanoporous material comprises a substrate without a membrane. The substrate may comprise a polymer (organic or inorganic), or a metallic material.

In some implementations, the separation/removal process can be based on permselectivity of graphene oxide membranes, molybdenum disulfide membranes, or carbon foams that allow ethanol to preferentially permeate the membrane over water and/or other compounds to enable the removal/separation of ethanol from a fluid. In some implementations, the separation/removal process is based on permselectivity of polymeric or metallic substrates pretreated with a wetting fluid that allow ethanol to preferentially permeate the substrate over water and/or other compounds to enable the removal/separation of ethanol from a fluid.

Some suitable methods of fabricating a semipermeable material comprising a membrane are disclosed below. It should be appreciated that other methods can also be used to fabricate the membrane.

In some implementations the semipermeable material can comprise a nanoporous membrane. In some implementations, the nanoporous membrane can comprise multilayered membranes. In some implementations, the multilayered membranes can comprise carbon-based layers, molybdenum-based layers, or the like. In various implementations, carbon-based multilayered membranes can comprise graphene oxide (GO) membranes. In various implementations, molybdenum-based multilayered membranes can comprise molybdenum disulfide (MoS₂) membranes. In some implementations, the semipermeable membrane can comprise a carbon-based foam.

In some implementations, aqueous monolayer suspensions of GO or MoS₂ can be prepared. In various implementations, the aqueous monolayer suspensions can be assembled into a nanoporous membrane.

GO membranes can be produced from commercial GO suspensions purchased from GOgraphene (William Blythe Limited, UK) or Graphenea, Inc. (Cambridge, MA). In various implementations, the GO water dispersion (e.g., GO flakes in water) can be prepared for application to a substrate. In some implementations, the GO water dispersion can be run through a centrifuge at low speed (e.g., about 2000 rpm or some other suitable speed). In some implementations, the precipitated solid from the centrifuge process is discarded until the density of the dispersion is adjusted to approximately 1.003 mg L-1 (e.g., the remaining GO suspension). In some implementations, GO flakes larger than 10,000 nm can be discarded from the GO suspension. In some implementations, this density can be reached in about four cycles of centrifuge process (e.g., one cycle may include running a GO water dispersion through the centrifuge and discarding the precipitate). In some implementations, 1 mL of the remaining GO water dispersion from one or more cycles of the centrifuge process can be diluted up to, for example, a volume of 10 mL with water. In some implementations, the water is a substantially pure water. In some implementations, the water is an ultrapure water such as can be obtained from a Mili-Q™ purification system. It should be appreciated that the water can be combined with one or more other compounds or products in some implementations.

In some implementations, GO solution can be diluted (e.g., 20 ml obtained from one of the above sources can be diluted in 200 ml of water). The resulting diluted solution can be sonicated for a suitable time (e.g., about 10 minutes) to enhance separation of monolayers within aggregates. The solution can then be centrifuged (e.g., about 3000 g for about 30 minutes) to separate heavier aggregates from lighter GO monolayers). These cycles of sonication and centrifugation can be repeated a desirable number of times (e.g., three times) until the resulting solution predominantly comprise exfoliated monolayers of GO. The exfoliated GO monolayers can be stored at refrigerated temperatures to minimize reduction prior to membrane formation.

In some implementations, just prior to use, the GO suspension in water can be sonicated in a sonicator bath for a predetermined period of time. In some implementations, the predetermined period of time of sonication can be 5 to 10 minutes or some other suitable time period. Other methods to resuspend the GO suspension can be used as well.

In some implementations, molybdenum-based membranes can be prepared following the method previously reported by Eda et al. (Eda, G., Yamaguchi, H., Voiry, D., Fujita, T., Chen, M. and Chhowalla, M. (2011) Photoluminescence from Chemically Exfoliated MoS₂. Nano Letters, 11, 5111-5116. https://doi.org/10.1021/nl201874w). Generally, lithium intercalation can be achieved by immersing 3 g of natural MoS₂ crystals (Sigma-Aldrich) in 3 ml of 1.6M butyllithium solution in hexane (Sigma-Aldrich) for about two days in a flask filled with argon gas. In some implementations, the LiₓMoS₂ can be retrieved by vacuum filtration and washed with hexane (e.g., four times with 50 ml hexane) to remove excess lithium and organic residues. Exfoliation can be achieved immediately after this (e.g., within about 30 minutes to minimized deintercalation) by ultrasonicating LiₓMoS₂ in water for one hour. The mixture can be centrifuged several times to remove excess lithium in the form of LiOH and unexfoliated material. The product can be referred to as an “aqueous monolayer suspension” of MoS₂.

In some implementations, aqueous monolayer suspension of GO or MoS₂ can be deposited onto a porous substrate. In various aspects, deposition onto a porous substrate can enhance mechanical stability of the resulting nanoporous membrane. In some implementations, deposition of aqueous monolayer suspensions of GO or MoS₂ can be achieved by such processes as vacuum filtration, pressure-induced filtration, slot-die coating, or the like.

In some implementations where the semipermeable material comprises one or more graphene oxide layers and a substrate, the membrane is prepared by vacuum filtration of a graphene oxide water dispersion on the substrate. In some implementations, the process of preparing the membrane includes starting with a water dispersion of graphene oxide. For example, the graphene oxide water dispersion can include 0.4% by weight graphene oxide (GO) flakes in water. The graphene oxide dispersion is applied to a substrate in one or more steps by various methods described herein.

In some implementations, the semipermeable membrane can comprise a carbon-based foam. In some aspects, carbon-based foams can comprise carbon fibers stacked together leading to a hierarchical structure coupling micrometric scale confinement (interfiber porosity) to nanoscale confinement (individual fiber porosity). In some implementations, carbon-based foams can comprise a GO foam or a carbon foam typically employed as electrodes for capacitor applications (e.g., commercially available from Kynol Europa GmbH). In some aspects, GO foams can be generated by freeze-drying a commercial GO aqueous suspension, such as the suspensions discussed elsewhere herein.

In various aspects, semipermeable material (e.g., membrane or foam) can be provided with a substrate. In various aspects, substrate can be included on one or both sides of a semipermeable material. For example, in some implementations, carbon-based foams can be encapsulated between two substrates, thereby forming a substrate/foam/substrate structure. In some implementations, provision of a foam between two substrates can provide additional stability to the foam, which may be beneficial during use. In some implementations, foam can be encapsulated between two Nylon substrates or two polycarbonate substrates.

In some implementations, a substrate can comprise a polymer membrane or sheet. In some implementations, a polymer membrane or sheet can comprise a polymer selected from polytetrafluoroethylene (PTFE, commonly referred to as Teflon®), polyethersulphone (PES), polycarbonate (PC), polyvinylidene fluoride (PVDF), polysulfone (PSF), polyvinyl chloride (PVC), polyamide (Nylon), and the like, or combinations or blends of any two or more of these. Other suitable polymers can include, for example, cellulose acetate (CA), nitrocellulose (NC), polyimide (PI), polyacrylonitrile (PAN), polypropylene (PP), polyethylene (PE), polyvinyl alcohol (PVA), poly(4-methyl-1-pentene), poly(dimethyl siloxane) (PDMS), poly(arylene ether ketone) (PAEK), poly(ether imide) (PEI), and polyethersulfone amide (PESA), and the like, or combinations or blends of any two or more of these.

In some implementations, polymer layer (such as PTFE) can be laminated onto a netting or nonwoven backing (for example, polypropylene netting or nonwoven polypropylene backing), or unlaminated. In some implementations, substrate polymer can be hydrophobic. In some aspects, “hydrophobic” means a polymer that is non-polar in nature and is thus not soluble in water or other polar solvents. In some implementations, a polymer layer or sheet can include surface architecture. One suitable polymer layer including surface architecture comprises a polycarbonate track etch (PCTE) layer. In some implementations, a polymer sheet or layer can comprise a polyamide, such as Nylon.

In some implementations, a substrate can comprise metallic mesh, aluminum, alumina (aluminum oxide, including anodic aluminum oxide (AAO)), copper, or active carbon, e.g., substrates having pore size in a range of about 10 nm to about 500 nm, or about 20 nm to about 450 nm.

In some implementations, a substrate can comprise a carbon substrate. In various implementations, a carbon substrate can comprise a nanocarbon material. In some implementations, the nanocarbon material can comprise a one-dimensional carbon nanotube (CNT). Suitable CNT can be prepared as hollow fibers. Such CNT hollow fibers can be prepared through a wet-spinning method coupled with pyrolysis, as discussed by Fan, X. et al., “A novel reduced graphene oxide/carbon nanotube hollow fiber membrane with high forward osmosis performance,” Desalination 451 (2019) 117-124. Graphene oxide can be fabricated from a modified Hummers method, then exfoliated in distilled water (approximately 1.0 mg/ml) under ultrasonication for 4 hours. A homogeneous GO suspension is obtained after centrifugation at 8000 rpm for 5 minutes. In some implementations, the GO can then be coated onto the CNT hollow fiber membrane via in a titanium tube with one end sealed with Teflon®. A direct current voltage of 3.5 V is applied between a titanium cathode and CNT hollow fiber anode. After deposition for 30 seconds, the sample is chemically reduced by introducing hydriotic vapor into the lumen side for 5 minutes.

In some implementations, a membrane can include more than one substrate. Similar all-nanocarbon based membranes can be utilized in accordance with concepts described herein.

In some implementations, the GO suspension can be applied to more than one surface of a substrate.

In some implementations, the GO suspension can be applied to a substrate by vacuum filtration. In these aspects, the GO suspension can be fed into a pressure filtration device that contains a substrate. In some implementations, the pressure filtration device includes a feed side and a draw side. In some implementations, the feed side and the draw side of the pressure filtration device can be separated by a substrate, such as the polymer layer discussed herein. In some implementations, the draw side may include an outlet pipe and/or draw reservoir. In some implementations, the feed side may include an inlet pipe and/or a feed reservoir. For example, the GO suspension can be fed into a pressure filtration device that contains a polycarbonate sheet or layer that will allow water molecules to pass but will capture or retain the GO in the water suspension. In some implementations, the substrate can cover any suitable area and can be in a range of about 20 μm to about 30 μm in thickness, or in a range of about 22 μm to about 28 μm. In some implementations, the substrate can be approximately 24 μm in thickness. It should be appreciated that the thickness of the substrate can be other suitable thicknesses depending on the application. For example, in higher pressure applications, the substrate thickness may be increased to add strength to the resulting structure to withstand added pressure.

In some implementations, a substrate can be characterized by porosity of about 4.7% and average pore size in a range of about 10 nm to about 12,000 nm. In some implementations, the average pore size can be in a range of about 10 nm to about 12,000 nm, or about 20 nm to about 10,000 nm, or about 20 nm to about 1,000 nm, or about 20 nm to about 500 nm, or about 20 nm to about 450 nm. It should be appreciated that other substrates with other suitable porosities can be used. In some implementations, the substrate is tested within the pressure filtration device to ensure that water does not leak from unintended areas of the pressure filtration device. In some implementations, the substrate within the pressure filtration device should be substantially leak free.

In some implementations, the GO suspension is added to the pressure filtration device and a pressure is applied to the GO suspension against the substrate in the pressure filtration device. In some implementations, the pressure is applied to the GO suspension with a gas, such as an inert gas like Argon. It should be appreciated that other suitable gasses can be used, and other suitable mechanisms can be used to apply pressure to the GO suspension. In some implementations, an inert gas such as Argon can be applied with a substantially constant pressure. For example, the gas may be applied with 1 bar of pressure in some implementations. In some implementations, once a flow of water (e.g., from the GO suspension) is detected on an outlet pipe of the pressure filtration device, the pressure can be increased. In some implementations, the pressure can be increased to 2.5 bars or some other suitable amount of pressure. In some implementations, the pressure can be higher or lower. In some implementations, some level of pressure is applied to the GO suspension in the pressure filtration device until water is removed and one or more layers of GO are applied to the substrate in the pressure filtration device. In some implementations, the process is complete when substantially all of the water from the GO suspension flows into the draw side of the pressure filtration device. In some implementations, a transparent solution of water is recovered from the draw side of the pressure filtration device when the fabrication of the GO layer(s) on the substrate proceeds appropriately (e.g., no tears or fissures are formed in the GO layers). It should be appreciated that in some implementations, a GO layer comprises one or more flakes of GO. In some implementations, multiple GO layers comprise layers of GO flakes. In some implementations, the remaining GO layer(s) are kept under pressure for a predetermined period of time. In some implementations, the predetermined period of time under pressure is 2 hours (or some other suitable period of time) after the last detectable water molecule is released from the pressure filtration device. In some implementations, the one or more GO layers in combination with the substrate form a GO membrane (GOM).

In some implementations, an aerogel layer can be added as a layer on top of the GO side of the GOM. In some implementations, the aerogel layer creates vertical structures on the surface of the GOM such that when fluid is flowed tangentially over the aerogel layer of the GOM, the vertical structures of the aerogel layer create a mixing action for the fluid flowing over the GOM to break up any concentration polarization (or gel polarization) layers that may build up in the fluid flow near the surface of the GOM.

It should be appreciated that in some implementations, a GOM can be formed without additional non-graphene based layers (e.g., without the substrate). That is, in some implementations, a GOM can be formed from one or more layers of GO flakes.

In alternative implementations, the GO layers (layers of GO flakes) can be made by alternative methods. For example, the GO layers can be prepared using the Hummers method (e.g., by treating natural graphite flakes and treating these flakes with potassium permanganate and sodium nitrate in concentrated sulphuric acid). Another alternative method of preparing the GO layers includes the Brodie method (adding potassium chlorate to a slurry of graphite in fuming nitric acid). The resulting GO can be added to a porous substrate layer using alternative techniques such as spray coating, casting, dip coating, and the like.

In some implementations where the semipermeable material comprises membrane (e.g., graphene oxide) and a substrate, the membrane is prepared by printing a graphene oxide dispersion on the substrate. In some implementations, graphene oxide dispersion is printed onto a substrate using methods such as slot-die coating or roll to roll processing (e.g., roll to roll lithography). Generally speaking, such coating methods produce thin films via solution processing. In accordance with these aspects, GO dispersion can be delivered onto the surface of the substrate through a precise coating head (e.g., a slot-die or other printing head). In some implementations, the process of preparing the graphene oxide includes starting with a water dispersion of graphene oxide. For example, the graphene oxide water dispersion can include 0.4% by weight graphene oxide (GO) flakes in water.

In some implementations, a substrate can comprise one or more polymer layers or sheets as previously described. In some implementations, a substrate can comprise metallic mesh, aluminum, alumina (aluminum oxide), copper, or active carbon as previously described. In some implementations, a membrane can include more than one substrate.

In some implementations, a structural material can be included in the semipermeable material. The structural material can comprise one or more layers within the semipermeable material. The structural material can be applied at any location within the semipermeable material, for example, at a fluid-contacting surface of a membrane (e.g., the feed liquid contacting surface or draw liquid contacting surface), or at an interior location (such as a location between two other layers of membrane and/or substrate).

In some implementations, structural material can comprise a material that provides additional strength or structure to the membrane. For example, structural materials can include silicone, graphene, or the like.

In some implementations, the structural material can be provided in a patterned layer so that it does not interfere with the permeability of the semipermeable (e.g., nanoporous) material. For example, in some implementations, the structural material can be provided in a honeycomb or other open pattern so that the material can provide additional structure and strength to the overall material without adversely impacting the permselectivity of the membrane and/or substrate. In some implementations, the structural material can be provided on all, or less than all, of the surface area of a membrane and/or substrate. In some implementations, structural material can be provided as a strip along the perimeter of a membrane and/or substrate, to provide support around the perimeter for handling. In some implementations, structural material can be provided as an open pattern (e.g., honeycomb) on all of the surface area in a plane of the membrane and/or substrate.

In some implementations, a GO water dispersion (e.g., GO flakes in water) can be run through a centrifuge at low speed (e.g., 2000 rpm or some other suitable speed). In some implementations, the precipitated solid from the centrifuge process is discarded until the density of the dispersion is adjusted to approximately 12 mg/ml (e.g., the remaining GO suspension). In some implementations, GO flakes larger than 10,000 nm can be discarded from the GO suspension. In some implementations, this density can be reached in about four cycles of centrifuge process (e.g., one cycle may include running a GO water dispersion through the centrifuge and discarding the precipitate). In some implementations, 1 mL of the remaining GO water dispersion from one or more cycles of the centrifuge process can be diluted with a suitable diluent to provide a desired final concentration. For example, in some implementations, 1 L of the GO water dispersion can be diluted up to, for example, a volume of 100 mL with a suitable diluent. In some implementations, the diluent comprises water or an alcohol. In some implementations, the water is a substantially pure water. In some implementations, the water is an ultrapure water such as can be obtained from a Mili-Q™ purification system. It should be appreciated that the water can be combined with one or more other compounds or products in some implementations. In some implementations, the alcohol can be selected from alcohols described elsewhere herein as suitable wetting fluids. In some implementations, the alcohol can comprise ethanol.

In some implementations, the GO suspension in water is rejuvenated before coating by sonication and/or blending to redistribute any aggregated GO flakes. In some implementations, GO suspension in water is rejuvenated by sonication in a sonicator bath for a predetermined period of time. In some implementations, the predetermined period of time of sonication can be 10 minutes or some other suitable time period. The GO suspension can then be diluted as desired. In some implementations, 10 ml of GO suspension is diluted in 90 ml of distilled water to provide a thinner coating.

In some implementations, slot-die coating can be accomplished using a nano roll coater, such as the Nano Roll Coater slot die coating machine manufactured by FOM Technologies (Denmark).

For slot-die coating, a selected substrate is loaded onto the support drum of the roll coater, and the drum temperature is raised to a desired setpoint. In some implementations, a desired setpoint may be an elevated temperature that increases the rate of drying of the GO suspension on the substrate. In some implementations, the support drum is heated to a desired temperature (setpoint) of 60° C. The slot die head is lowered to a position just above the substrate (such as 5 mm). The drum with mounted substrate is rotated until a small length of substrate protrudes beyond the slot die head toward the user (for example, 0.5 cm). The direction of coating proceeds toward the user, meaning that the majority of the substrate length is wrapped around the drum toward the back of the machine.

The sample syringe of the slot-die machine is then loaded with the GO suspension, and the tubing line is primed with the GO suspension by driving the syringe pump independently until a small drop of coating fluid is visible protruding from the slot die coating lip. The coating process is initiated by selecting the flow rate and coating speed in the slot-die user interface. The slot die head is then lowered the remaining distance to the substrate until film formation of the GO suspension is observed on the substrate. The distance between the slot die head and substrate can be referred to as the working distance. This working distance can affect the coating strip width applied to the substrate and is not a primary parameter for controlling wet film thickness of a coated layer. In some implementations, the working distance can be about 40 μm, although other working distances may also be used. The slot die head may be manually adjusted to include the coating strip edges, per manufacturer directions.

In some aspects, GO coated layer thickness can be primarily impacted by such factors as the rate of fluid pumping via the syringe pump, the speed of substrate beneath the slot die head, and/or the width of the coated stripe. In some implementations, decreasing the pump speed, increasing the substrate speed, and/or increasing the coating width can decrease the wet coated GO layer thickness, and vice versa. In some implementations, GO suspension is applied via a slot die coating machine at a flow rate of about 2 ml/min to about 6.5 ml/min, or about 4.5 ml/min to about 6.5 ml/min, although other flow rates may be used. In some implementations, coating width can be about 100 mm and coating speed can be about 70 cm/min, although other coating widths and speeds can be used as desired. In some implementations, for example, when a thicker coating is desired, coating speed can be 10 cm/min and flow rate can be about 4 ml/min.

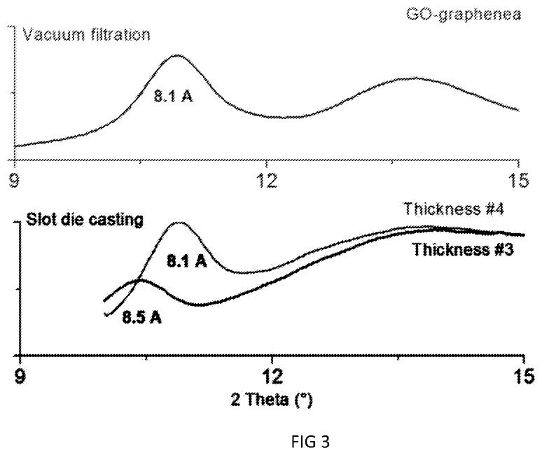

In some implementations, the coating process proceeds until the desired coating thickness is achieved. In some implementations, when coating GO suspension onto a porous polycarbonate substrate using a FOM Nano Roller Coater as described, target thickness and width of the final membrane can be about 0.5 μm to about 1 μm and about 40 nm to about 90 nm, respectively. Final dimensions of the membrane coating can be adjusted depending upon the application, so that thickness and width can vary. In some implementations, multiple coatings of GO suspension can be applied to achieve a target thickness. In some implementations, a thin membrane can be produced by diluting the GO suspension prior to application to the substrate. In some implementations, a thicker membrane can be produced by coating at a higher speed, such as 10 cm/min and/or at a higher pump rate (such as about 4 ml/minute). In some implementations, membrane thickness can be characterized by profilometry or cross-sectional scanning electron microscopy (SEM). In some implementations, order of stacking of GO flakes and membrane integrity can be characterized by SEM and/or X-ray diffraction (XRD) analysis. FIG. 3 illustrates imaging of a membrane produced by slot die coating as compared to coating by vacuum filtration methods.

In some implementations, the substrate is maintained on the support drum a suitable amount of time to allow the substrate to dry before applying additional layers of GO and/or being removed from the coating machine.

In some implementations, larger scale production of membranes can utilize concepts of slot-die coating. In some implementations, membranes can be fabricated using roll to roll processing.

In some implementations, the GOM may include one or more layers of GO flakes. In some implementations, the GOM may include 10,000 layers of GO flakes. In accordance with some principles, the thickness of the layers of GO flakes in the GOM has an impact on selectivity of compounds. While it may seem that thinner layers of GO flakes should equate to more of a compound being filtered more easily from a liquid, a certain thickness of the GO flake layers may be needed to optimize filtration selectivity of a compound (e.g., selectively filtering ethanol from an alcoholic beverage). That is, in accordance with some aspects, a certain range of thickness of the layers of GO flakes can provide better filtration selectivity of a compound over thinner layers of GO flakes. For example, if the GO layers are too thin, the GO layers may not hold enough of a wetting compound to induce filtration selectivity (e.g., if the GOM is wetted to selectively filter ethanol, if the layers of GO flakes in a GOM are not thick enough, the layers of GO flakes may not hold enough wetting compound after a wetting period to selectively filter ethanol from an alcoholic beverage applied to one side of the GOM). In some implementations, the GO layers of thickness in a GOM is in a range of 100 nm to 5000 nm. In some implementations, the GO layers of thickness in a GOM is in a range of 200 nm to 4000 nm. In some implementations, the GO layers of thickness in a GOM is in a range of 300 nm to 3000 nm. In some implementations, the GO layers of thickness in a GOM is in a range of 400 nm to 2500 nm. In some implementations, the GO layers of thickness in a GOM is in a range of 500 nm to 2000 nm. In some implementations, the selection of the range of GO layer thickness can depend on one or more factors, such as temperature, type of liquid, type of compound that will be filtered from a liquid, altitude at which the process will be conducted, and the like. In some implementations, the GOM may include multiple layers of GO that, when combined, provide an overall thickness of GO layers in a range of about 10 μm to about 30 μm. In some implementations, when the surface area of a GOM is increased, the layers of GO flakes are increased, and the thickness is also increased. It should be appreciated that a GOM may have more or fewer layers of GO flakes.

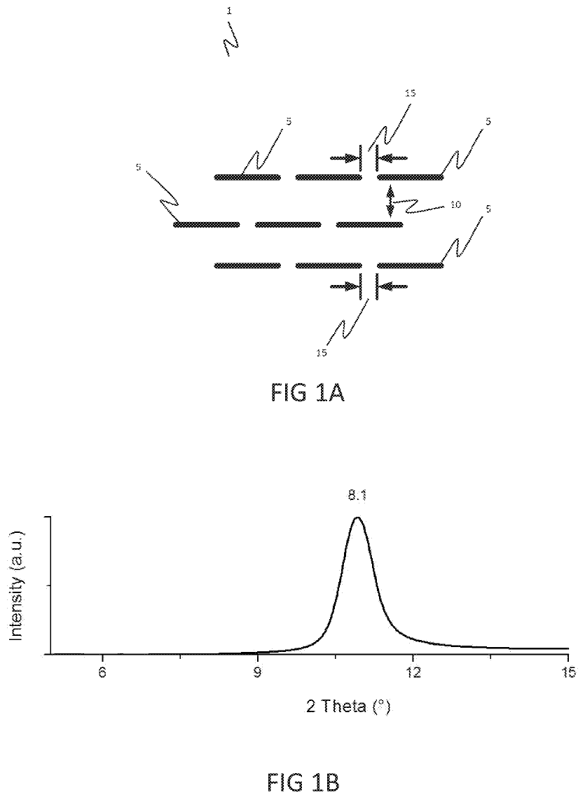

In some implementations, the process of making the GOM includes using GO flakes having an average width in a desired range. For example, in some implementations, the GO flakes having an average width in a range of about 100 nm to about 10,000 nm, or about 200 nm to about 800 nm, or about 300 nm to about 600 nm, or about 400 nm to about 500 nm can be useful in accordance with some principles. In some implementations, GO flakes having a particular average width can be selected based upon such factors as, for example, temperature, type of liquid, type of compound that will be filtered from a liquid, altitude at which the method will be performed, and the like. In some implementations, the in-plane spacing and the inter-plane spacing of the GO flakes in the GOM can be significant to the process of filtering an organic compound. FIG. 1A illustrates reference 1, which is a closeup cross section view of a few layers of GO in a GOM in some implementations. The GO flakes 5 are layered upon each other and generally have in-plane spacing and inter-plane spacing with respect to each other. In some implementations, the GO flakes include an in-plane spacing 15 of approximately 2 nm. In some implementations, the GO flakes include an inter-plane spacing 10 of approximately 1 nm. In some implementations, a beneficial range of the inter-plane spacing between GO flakes is in a range of about 0.7 nm to about 1.5 nm. When the inter-plane spacing between GO flakes is less than about 0.7 nm, then organic molecules such as ethanol will be restricted from passing through the GOM. When the inter-plane spacing between GO flakes is greater than about 1.5 nm, then preferential passage of a particular organic molecule (e.g., ethanol) may be lost and unwanted molecules (e.g., water and/or other compounds) may be permitted to pass through the GOM along with the organic molecules that are desired to be filtered through the GOM. In some implementations, a GO membrane can have a pore size distribution of about 1.5 nm to about 7 nm, or about 1.8 nm to about 6 nm. It should be appreciated that the methods of forming the GOM discussed herein are suitable ways to achieve an appropriate in-plane and inter-plane spacing between the GO flakes and GO layers to permit the permselectivity.

In some implementations, GO flakes are formed from cooking a carbon-based material. In some implementations, the carbon-based material can be caramel. In some implementations, GO flakes can be made purer by at least partially removing oxygen from the carbon-based material used to form the GO flakes. In some implementations, oxygen can be removed from the GO using ascorbic acid during the process.

In some implementations, GO membrane production can be scaled up with larger quantities of suspension of GO. In some implementations, the scaled-up production of GO may include 9 mL of higher diluted dispersion of GO flakes diluted up to a total volume of 90 mL with water (e.g., purified water or other suitable water). The suspension of GO flakes in water is further sonicated in a sonicator bath for a predetermined period of time (e.g., 5 minutes) and then fed to a pressure filtration device that already contains a substrate. The substrate may comprise a surface area and be approximately 24 μm thick with a porosity of about 4.7% and average pore size of about 200 nm. It should be appreciated that other suitable water permeable substrates can have different properties.

As previously noted, in some implementations, properly formed GO layers in a GOM substantially lacks cracks, tears, or fissures in the GO layers of the GOM. The structural characterization of properly formed GO films reveals an absence of such cracks, tears, or fissures throughout the GOM (while still including nanoporous regions in the GOM or GO layers). As illustrated in FIG. 1B, an X-Ray diffractogram of a GOM composed of graphene oxide that shows the presence of GO as a broad/high peak substantially centered around 10 degrees is usually attributed to GO layers of the GOM having the absence of problematic cracks, tears, and/or fissures in some implementations. In some implementations, a low peak in the X-Ray diffractogram of the GO may indicate possible problems with the integrity of the GO layers of the GOM.

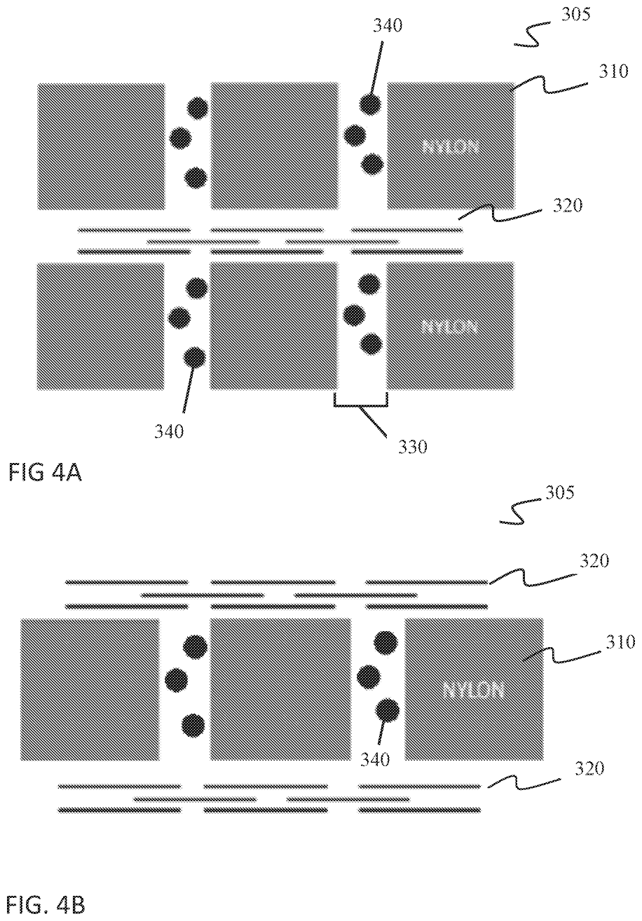

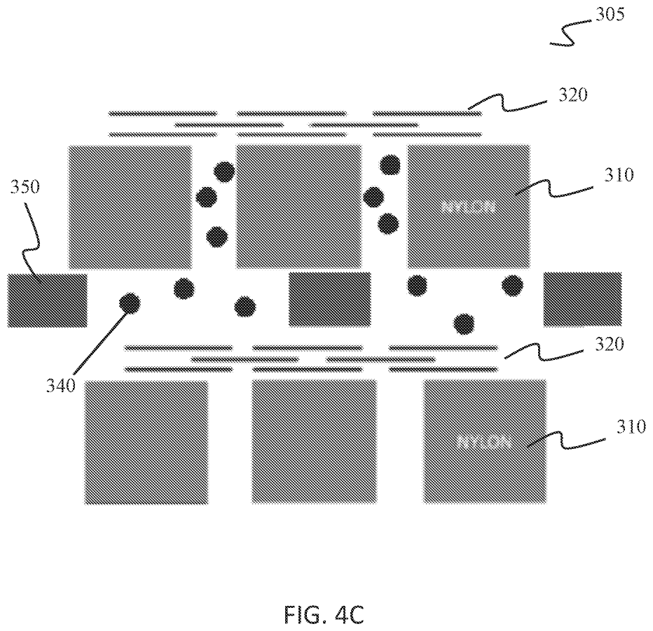

In some implementations, GO membranes can include alternating layers of GO and substrate. In some implementations, GO membranes can include an alternating structure having three layers. For example, in some aspects GO membranes can include more than one substrate layer. In some implementations, GO membrane can include GO layers positioned between a first substrate layer and a second substrate layer to form a GOM having a sandwich structure comprising: first substrate layer/GO layers/second substrate layer. For example, in some implementations, GOM comprises substrate on each of the fluid contacting surfaces. The first substrate layer and second substrate layer can comprise the same material or different material. In some implementations, GOM can comprise a structure: Nylon/GO layers/Nylon, as illustrated in FIG. 4A. In another example, GO membranes can include a substrate positioned between a first GO layer and a second GO layer to form a GOM having a sandwich structure comprising GO layers/substrate/GO layers. In this aspect, GOM comprises GO layers on each of the fluid contacting surfaces. The first GO layer and second GO layer can each comprise a thickness. The thickness of the first GO layer can be the same as, or different from, the thickness of the second GO layer. In some implementations, GOM can comprise a structure: GO layers/Nylon/GO layers, as illustrated in FIG. 4B.

In some implementations, GO membrane can include alternating layers of GO and substrate to provide a final product having more than three layers. In some implementations, GO membrane can include alternating substrate/GO layers to provide an overall GOM comprising a structure: substrate/GO/substrate/GO, thus including two layers of GO and two layers of substrate, wherein the identity of each substrate layer can be independently selected. In some implementations, the substrate layers comprise the same material. In some implementations, the substrate layers comprise different materials. Similarly, the specific identity of each GO layer can be the same or different, as desired. The total number of GO layers and substrate layers, as well as their specific sequence, can be selected as desired.

In some implementations, GO membrane can be assembled to include multiple layers of GO and substrate in an irregular (non-repeating) pattern. One suitable example is shown in FIG. 4C, wherein the GO membrane includes a structure: GO/substrate/substrate/GO/substrate. In the embodiment illustrated, two different substrates are utilized, and the pore size of the membrane thus differs by layer. In some implementations, the substrate layers can have a pore size that is larger than the pore size of the GO layers. In the example of FIG. 4C, nylon as a substrate has a pore size of 200 nm, while PVC substrate has a pore size of 5000 nm. It will be understood the specific identity of each layer of a GOM can be selected to provide an overall membrane profile as desired.

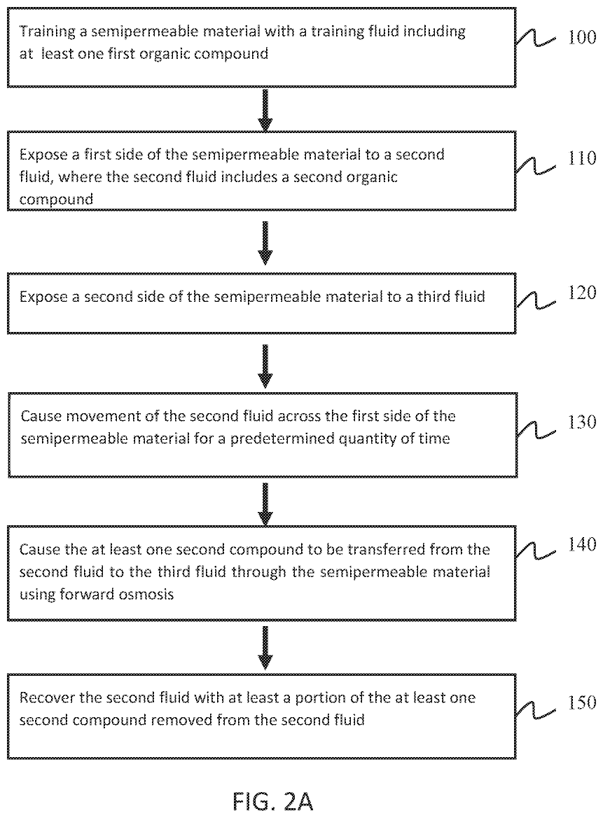

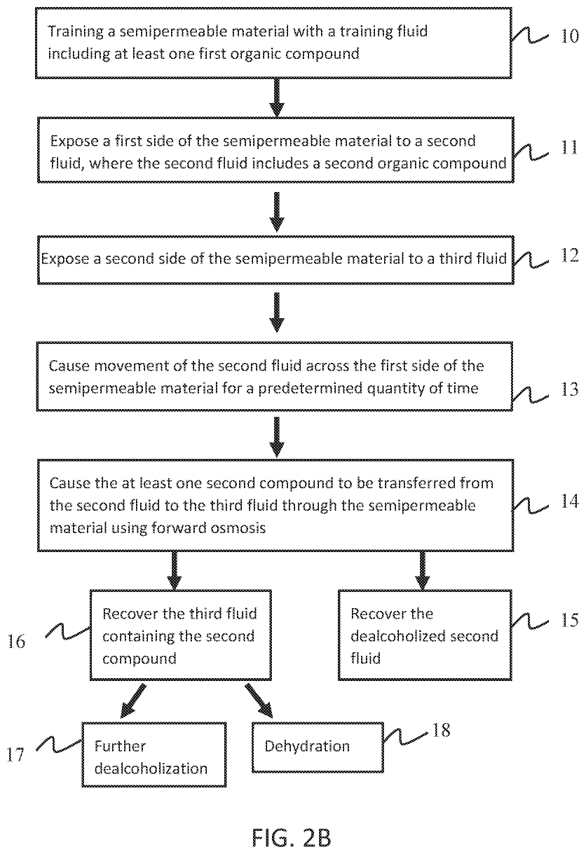

Turning to FIG. 2A, a process diagram is shown illustrating a method of filtering one or more compounds from a fluid with a filtration system using a semipermeable material in accordance with some implementations. Methods will be discussed with respect to a filtration system using a membrane for purposes of illustration. It will be understood, however, that methods of wetting and filtering one or more compounds from a fluid include methods using a filtration system comprising semipermeable material that can comprise a membrane, a substrate (without membrane), or a combination of membrane and substrate, as well.

In some implementations, as shown in block 100, the process includes wetting a semipermeable material (e.g., membrane) with a wetting fluid including at least one first organic compound. In some implementations, the membrane can be a carbon-based membrane (e.g., a GO based membrane, such as the GOM discussed above), a molybdenum-based membrane (e.g., MoS₂), or a carbon-based foam. While GOM is used as an illustrative membrane in the discussions below, it should be appreciated that other suitable membranes and substrates with the same or similar characteristics can be used. For example, the semipermeable material can comprise one or more layers of GO alone. In some implementations, the semipermeable material can comprise one or more layers of substrate alone. In various implementations, the semipermeable material can comprise a one or more GO layers in combination with one or more substrate layers. In some implementations, the membrane can include a structural material.

In some implementations, a substrate can comprise a polymer membrane or sheet. In some implementations, a polymer membrane or sheet can comprise a polymer selected from polytetrafluoroethylene (PTFE, commonly referred to as Teflon®), polyethersulphone (PES), polycarbonate (PC), polyvinylidene fluoride (PVDF), polysulfone (PSF), polyvinyl chloride (PVC), polyamide (Nylon), and the like, or combinations or blends of any two or more of these. Other suitable polymers can include, for example, cellulose acetate (CA), nitrocellulose (NC), polyimide (PI), polyacrylonitrile (PAN), polypropylene (PP), polyethylene (PE), polyvinyl alcohol (PVA), poly(4-methyl-1-pentene), poly(dimethyl siloxane) (PDMS), poly(arylene ether ketone) (PAEK), poly(ether imide) (PEI), and polyethersulfone amide (PESA), and the like, or combinations or blends of any two or more of these.

In some implementations, polymer layer (such as PTFE) can be laminated onto a netting or nonwoven backing (for example, polypropylene netting or nonwoven polypropylene backing), or unlaminated. In some implementations, substrate polymer can be hydrophobic. In some aspects, “hydrophobic” means a polymer that is non-polar in nature and is thus not soluble in water or other polar solvents. In some implementations, a polymer layer or sheet can include surface architecture. One suitable polymer layer including surface architecture comprises a polycarbonate track etch (PCTE) layer. In some implementations, a polymer sheet or layer can comprise a polyamide, such as Nylon.

In some implementations, a substrate can comprise metallic mesh, aluminum, alumina (aluminum oxide, including anodic aluminum oxide (AAO)), copper, or active carbon, e.g., substrates having pore size in a range of about 10 nm to about 500 nm, or about 20 nm to about 450 nm. In some implementations, a substrate can comprise a carbon substrate. In various implementations, a carbon substrate can comprise a nanocarbon material. In some implementations, the nanocarbon material can comprise a one-dimensional carbon nanotube (CNT). Suitable CNT can be prepared as hollow fibers. Such CNT hollow fibers can be prepared through a wet-spinning method coupled with pyrolysis, as discussed by Fan, X. et al., “A novel reduced graphene oxide/carbon nanotube hollow fiber membrane with high forward osmosis performance,” Desalination 451 (2019) 117-124. Graphene oxide can be fabricated from a modified Hummers method, then exfoliated in distilled water (approximately 1.0 mg/ml) under ultrasonication for 4 hours. A homogeneous GO suspension is obtained after centrifugation at 8000 rpm for 5 minutes. The GO can then be coated onto the CNT hollow fiber membrane via in a titanium tube with one end sealed with Teflon®. A direct current voltage of 3.5 V is applied between a titanium cathode and CNT hollow fiber anode. After deposition for 30 seconds, the sample is chemically reduced by introducing hydriotic vapor into the lumen side for 5 minutes.

Unexpectedly, it has been found that wetting the semipermeable material (e.g., GOM) with a wetting fluid comprising a first organic compound can cause the GOM to preferentially permit a second organic compound to more readily pass through the membrane when later exposed to other fluids that contain the second organic compound. In some implementations, wetting a GOM includes exposing the GOM to a wetting fluid including at least one first organic compound.

In some implementations, the first organic compound of the wetting fluid is an alcohol that is different from the second organic compound. In some implementations, the second organic compound comprises ethanol, and the first organic compound of the wetting fluid comprises an alcohol other than ethanol. In some implementations, the first organic compound comprises heptanol or butanol. In some implementations, the first organic compound comprises an alcohol having about 2 to about 24 carbon atoms. Suitable alcohols can comprise primary, secondary or tertiary alcohols, can be allylic or benzylic, can be saturated or unsaturated, and can be linear, branched, or cyclic. In some implementations, the first organic compound of the wetting fluid is an alcohol that is the same as the second organic compound. In some implementations, the first organic compound of the wetting fluid and the second organic compound are ethanol.

In some implementations, the first organic compound comprises an alcohol selected from methanol, ethanol, 1-propanol, 2-propanol, 1-butanol, 2-butanol, 2-methyl-1-propanol (isobutyl alcohol), 2-methyl-2-propanol, 1-pentanol, 3-methyl-1-butanol (isopentyl alcohol), 2,2-dimethyl-1-propanol (neopentyl alcohol), cyclopentanol, 1-hexanol, cyclohexanol, 1-heptanol, 2-heptanol, 1-octanol, 1-nonanol, 1-decanol, phenylmethanol, diphenylmethanol (diphenylcarbinol), and triphenylmethanol (triphenylmethanol), or a combination of any two or more of these.

In some implementations, the first organic compound comprises a fatty alcohol that can be derived from natural fats and oils. In some implementations, suitable fatty alcohols are derived from vegetable oils, for example, having 6 to 24 carbon atoms. The precise chain length can vary depending upon the source of the alcohol. In some implementations, suitable fatty alcohols can be obtained from coconut oil (having 12 to 14 carbon atoms), palm kernel oil (having 16 to 18 carbon atoms), or rapeseed or mustard seed oil (having 20 to 22 carbon atoms). For fatty alcohols comprising a smaller number of carbon atoms, the wetting fluid can comprise a colorless oily liquid. For fatty alcohols comprising a larger number of carbon atoms, the alcohol can comprise a waxy solid.

Suitable first organic compounds include, but are not limited to, one or more fatty alcohols such as tert-butyl alcohol, tert-amyl alcohol, 3-methyl-3-pentanol, 1-heptanol, 1-octanol, 1-nonanol, 1-decanol, 1-undecanol, dodecanol (lauryl alcohol), 1-tridecanol, 1-tetradecanol, 1-pentadecanol, 1-hexadecanol, cis-9-hexadecen-1-ol, 1-n-heptadecanol, 1-octadecanol, 1-octadecenol, 1-nonadecanol, 1-eicosanol, 1-heneicosanol, 1-docosanol, cis-13-docosen-1-ol, and 1-tetracosanol.

Suitable first organic compounds include, but are not limited to, pentan-3-ol, 6-methylhept-5-en-2-ol, but-3-en-2-ol, 3,3-dimethylbutan-2-ol, 2,6-dimethylocta-1,5,7-trien-3-ol, dodecan-2-ol, 2-methylhexan-3-ol, 3-methylpentan-2-ol, 4-methylpentan-2-ol, non-1-en-3-ol, nonan-3-ol, octa-1,5-dien-3-ol, undeca-1,5-dien-3-ol, and (Z)-4-hepten-2-ol.

In some implementations, first organic compounds can comprise a viscosity that allows the wetting fluid to be retained within pores of the semipermeable material. In some implementations, first organic compounds can have a kinematic viscosity in a range of about 0.55 to about 15 cP at standard conditions.

In some implementations, the wetting fluid comprises the first organic compound in an amount in a range of about 1% to about 99% by volume, or about 10% to about 99% by volume, or about 15% to about 99%, or about 20% to about 99% by volume, or about 25% to about 99% by volume, or about 30% to about 99% by volume. In some implementations, the first organic compound can be combined with a liquid with which it is miscible. In some implementations, the first organic compound is combined with water or ethanol. In some implementations, the wetting fluid comprises the first organic compound at a concentration of about 50% (by volume) in ethanol.

In some implementations, the wetting fluid comprises heptanol (C₇H₁₆O). In some implementations, heptanol comprises 1-heptanol or heptan-2-ol. In some implementations, the wetting fluid is substantially pure heptanol. In some implementations, heptanol is present at a concentration up to about 99% (by volume) in ethanol or water. In some implementations, heptanol is present at a concentration in a range of about 10% to about 99%, or about 15% to about 99%, or about 20% to about 99%, or about 30% to about 99% (by volume) in ethanol or water. In some implementations, a wetting fluid comprises heptanol at a concentration of about 50% (by volume) in ethanol.

In some implementations, the wetting fluid comprises butanol (C₄H₁₀O). In some implementations, butanol comprises butan-1-ol. In some implementations, the wetting fluid is substantially pure butanol. In some implementations, butanol is present at a concentration up to about 99% (by volume) in ethanol or water. In some implementations, butanol is present at a concentration in a range of about 10% to about 99%, or about 15% to about 99%, or about 20% to about 99%, or about 30% to about 99% (by volume) in ethanol or water. In some implementations, a wetting fluid comprises butanol at a concentration of about 50% (by volume) in ethanol.

In some implementations, the wetting fluid is a substantially purified form of the at least one first organic compound. For example, wetting a GOM may include dipping a GOM in a wetting fluid of an alcohol having 24 or fewer carbon atoms. In some implementations, the alcohol is substantially pure alcohol (e.g., 99% pure alcohol). It should be appreciated that the percentage of alcohol of the wetting fluid can be any suitable percentage. In some implementations, the percentage of alcohol of the wetting fluid is in a range of 20% to 100%. In some implementations, the wetting fluid comprises an alcohol combined with water or with another lower chain alcohol, for example, ethanol. In some embodiments, for example, for longer chain fatty alcohols, the wetting fluid can be heated and/or in solution with a lower chain alcohol to achieve a desired viscosity such that the wetting fluid can permeate the GOM.

In various aspects, wetting fluid can be selected based upon such factors as solubility in alcohol, insolubility in water, and viscosity. In some aspects, suitable wetting fluid can exhibit adequate viscosity to remain within the host semipermeable membrane during use.

In some implementations, wetting the semipermeable material (e.g., GOM) in the wetting fluid includes allowing the wetting fluid to substantially soak into the porous regions of the GOM. In various implementations, wetting the GOM in the wetting fluid can include one or more of dipping or soaking the nanoporous material in wetting fluid, applying the wetting fluid under gravity feed or pressure, by spray technique, evaporative deposition, and the like. In various implementations, the porous membrane network of the semipermeable material is saturated with the wetting fluid prior to conducting the separation process. For purposes of discussion, implementations involving GOM as the semipermeable material will be described. However, it will be understood that any of the other semipermeable materials described herein can be substituted for GOM.

In some implementations, the GOM is dipped or soaked in the wetting fluid for a predetermined amount of time. In some implementations, the predetermined amount of soaking time is 5 minutes. In some implementations, the thickness of the GOM and/or viscosity of the wetting fluid may dictate how long the GOM is soaked in the wetting fluid. It should be appreciated that the predetermined amount of soaking time can be any suitable time. In some implementations, wetting the GOM with a wetting fluid includes substantially removing or replacing air or air bubbles in the nanoporous regions of the GOM with the wetting fluid. In some implementations, properties of the GOM may include enabling the GOM to retain all or at least a portion of the wetting fluid once the GOM is used to filter one or more second organic compounds from a second liquid (as discussed below). That is, in some implementations, wetting a GOM enables the GOM to be saturated, which saturation can persist over time even as one or more compounds are passed through the GOM. In some implementations, at least a portion of the wetting fluid is retained in the GOM because the wetting fluid condenses within the interpores (or nanopores) of the GO layers of the GOM. It should be appreciated that in some implementations, none of the wetting fluid is retained in the GOM once the GOM is used to filter a second fluid. In some implementations, all or a portion of the wetting fluid in a GOM is replaced with one or more second organic compounds filtered from a second fluid.

In some implementations, wetting the GOM may include exposing the GOM to the wetting fluid under a gravity feed. For example, the GOM may be positioned between a top feed vessel and a bottom draw vessel, where the GOM is sealed between an interface between the top feed vessel and the bottom draw vessel. In some implementations, the seal between the top feed vessel and the bottom draw vessel with the GOM prevents fluid leaks between the vessels except through the GOM. The top feed vessel can be filled with the wetting fluid, which exposes one side of the GOM to the wetting fluid. In some implementations, gravity (in addition to capillary forces) may cause the wetting fluid to pass from the top feed vessel through the GOM to the bottom draw vessel. In some implementations, the GOM is properly wetted on the wetting fluid when a flow rate of the wetting fluid through the GOM reaches a substantially steady state flow rate. It should be appreciated that a GOM can be wetted when the flow rate of the wetting fluid is less than steady state in some implementations. In some implementations, it may be sufficient to have the bottom side of the GOM that interfaces with the bottom draw vessel substantially wetted with the wetting fluid.

In some implementations, wetting the GOM may include exposing the GOM to the wetting fluid under pressure. For example, the GOM may be positioned between a feed vessel and a draw vessel, where the GOM is sealed between the feed vessel and the draw vessel. In some implementations, the seal between the feed vessel and the draw vessel with the GOM prevents fluid leaks between the vessels except through the GOM. The feed vessel can be filled with the wetting fluid, which exposes one side (e.g., a first side) of the GOM to the wetting fluid. A vacuum can be applied to the draw vessel, which forcibly draws the wetting fluid through the GOM from the feed vessel to the draw vessel. In some implementations, wetting the GOM with a wetting fluid includes substantially saturating the nanoporous regions of the GOM with the wetting fluid. In some implementations, wetting the GOM with a wetting fluid also includes substantially removing or replacing air or air bubbles in the nanoporous regions of the GOM with the wetting fluid. In some implementations, the GOM is properly wetted on the wetting fluid when a flow rate of the wetting fluid through the GOM reaches a substantially steady state flow rate. It should be appreciated that a substantially steady state flow rate through the GOM is indicative of substantially removing or replacing air or air bubbles in the nanoporous regions of the GOM with the wetting fluid. It should also be appreciated that a GOM can be sufficiently wetted when the flow rate of the wetting fluid is less than steady state in some implementations. In some implementations, the other side (e.g., the second side or the draw vessel side) of the GOM should be substantially wet with the wetting fluid. In some implementations, the substantial saturation of the draw vessel side of the GOM prevents air bubbles or air pockets from forming on the surface of the draw vessel side of the GOM when another fluid or third fluid is added to the draw vessel, as is discussed below.

In some implementations, wetting the GOM may include soaking the GOM in wetting fluid for a suitable amount of time (for example, overnight) within a vacuum bell.

In some implementations, wetting the GOM may include exposing the GOM to the wetting fluid under pressure. For example, the GOM may be positioned between a feed vessel and a draw vessel, where the GOM is sealed between the feed vessel and the draw vessel. In some implementations, the seal between the feed vessel and the draw vessel with the GOM prevents fluid leaks between the vessels except through the GOM. The feed vessel can be filled with the wetting fluid, which exposes one side of the GOM to the wetting fluid. Pressure can be applied to the feed vessel and the wetting fluid, which forces the wetting fluid to pass from the feed vessel through the GOM to the draw vessel. In some implementations, pressure is applied with a gas on the feed vessel. In some implementations, the gas is an inert gas such as Argon. It should be appreciated that any suitable gas can be used to apply pressure on the feed vessel and the wetting fluid. In some implementations, wetting the GOM with a wetting fluid includes substantially saturating the nanoporous regions of the GOM with the wetting fluid. In some implementations, wetting the GOM with a wetting fluid also includes substantially removing or replacing air or air bubbles in the nanoporous regions of the GOM with the wetting fluid. In some implementations, the GOM is properly wetted on the wetting fluid when a flow rate of the wetting fluid through the GOM reaches a substantially steady state flow rate. It should be appreciated that a substantially steady state flow rate through the GOM is indicative of substantially removing or replacing air or air bubbles in the nanoporous regions of the GOM with the wetting fluid. It should also be appreciated that a GOM can be wetted when the flow rate of the wetting fluid is less than steady state in some implementations.

In some implementations, wetting the GOM may include casting an amount of wetting fluid over one side of the membrane and applying pressure (e.g., constant pressure) until the wetting fluid is observed to coat the opposite side of the membrane that was initially dry.

In some implementations, wetting the GOM may include misting (or spraying) the wetting fluid and forming a layer of the misted wetting fluid on one side of the GOM. After a predetermined period of time, wetting may further include adding another layer of misted wetting fluid on the same side of the GOM. In some implementations, adding an additional misted layer of the wetting fluid may continue until a predetermined amount of the wetting fluid appears to seep through to the opposite of the GOM (which may indicate that a substantial quantity of nanopores in the GOM have been saturated with the wetting fluid). In some implementations, adding additional one or more misted layers of the wetting fluid may continue until the opposite side of the GOM appears substantially saturated with the wetting fluid. In some implementations, the misting may include atomizing the wetting fluid. An advantage of atomizing the wetting fluid is the wetting fluid is broken into smaller droplets that more readily homogeneously wet the GOM and allow the wetting fluid to enter and permeate the nanopores of the GOM.

In some implementations, wetting the GOM may include evaporative deposition of wetting fluid on the membrane. In some implementations, the evaporative deposition of the wetting fluid can involve heating the wetting fluid in the presence of the membrane in a vacuum. In some implementations, the wetting fluid is heated to a temperature at which point it transitions from a liquid phase to gas phase (vaporizes). Because the membrane and wetting fluid are contained within a vacuum, the wetting fluid will transition to the gas phase at a temperature below its boiling point, and vapor particles are able to travel directly to the membrane, where they can then condense to a liquid state. The heated wetting fluid and membrane are maintained in vacuum for a suitable period of time, for example, an hour. The membrane including wetting fluid can then condense for a suitable amount of time. This completes one evaporative deposition cycle. If additional wetting fluid is desired, more than one evaporative deposition cycle can be performed, until the desired amount of wetting fluid has been applied to the membrane. In some implementations, exposure to vaporized wetting fluid may continue until a predetermined amount of the wetting fluid appears to seep through the sides of the GOM (which may indicate that substantial quantity of the nanopores in the GOM have been saturated with the wetting fluid). In some implementations, wetting the membrane further includes misting at least one layer of the wetting fluid on the membrane. In some implementations, wetting the GOM may include drop training, wherein the wetting fluid is applied to a surface of the membrane and allowed to soak into the membrane.

In some implementations, an advantage of vaporizing the wetting fluid can be that the wetting fluid is provided in smaller droplets that more readily homogeneously wet the GOM and allow the wetting fluid to enter and permeate the nanopores of the GOM.

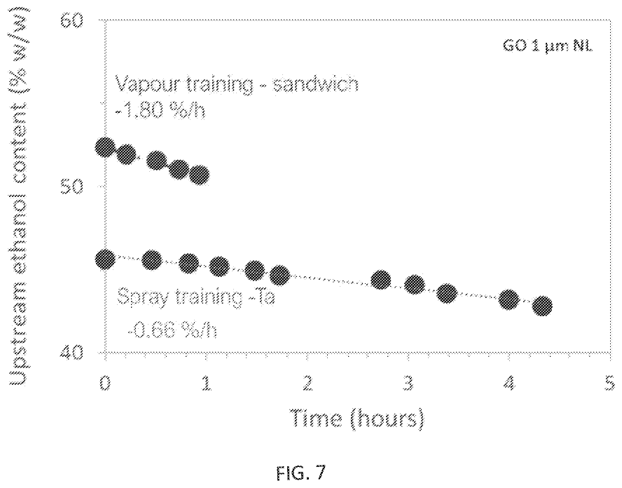

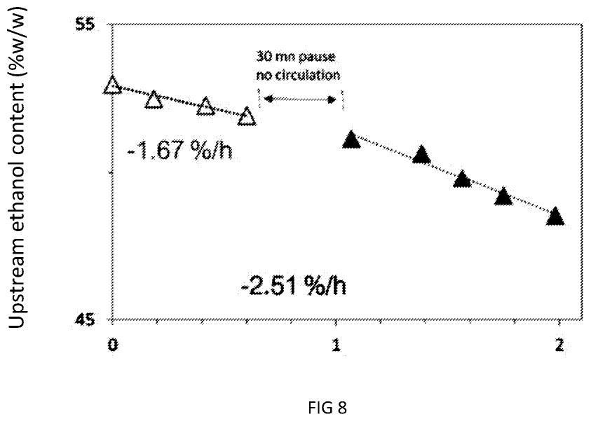

FIG. 7 shows a comparison of deposition techniques, in which a nanoporous material comprising GO layers (1 μm thick) and nylon were subjected to evaporative deposition with ethanol (top line) and spray wetting with ethanol (bottom line). For evaporative deposition, the nanoporous material was exposed to ethanol vapor at 40° C. for one hour under vacuum. As illustrated for this particular nanoporous material, evaporative deposition of the wetting liquid provided a nanoporous material that reduced ethanol content at a significantly faster rate than a nanoporous material prepared with spray wetting. It will be appreciated that deposition techniques can be selected depending upon such factors as the nanoporous material to be wetted, dimensions (such as thickness) of the nanoporous material, the wetting fluid to be applied, and the like.

In some implementations, wetting the GOM may include one or more of the above processes used in combination with each other. For example, in some implementations, the wetting fluid can be placed under pressure on the feed vessel side while the draw vessel side can be under a vacuum. It should also be appreciated that one or more other additional processes can be used to wet (e.g., train) the GOM for a particular compound. In some implementations, one or more of the wetting steps can be performed more than one time (e.g., can be repeated), as desired.

In some implementations, wetting the semipermeable material may include a single step or multiple-step process. In some implementations, wetting the semipermeable material may include multiple wetting steps, wherein each wetting step involves exposing the membrane to a wetting fluid under conditions sufficient to allow the wetting fluid to permeate and/or saturate the membrane. In some aspects, each wetting step can include exposing the membrane to a different wetting fluid. In some implementations, each wetting step can include exposing the membrane to the same wetting fluid. Each wetting step can be performed under the same, similar, or different conditions. In various implementations, wetting the semipermeable material produces a liquid infused material, such as a liquid infused membrane or foam.

In one embodiment, wetting methods can include exposing a semipermeable material to a first wetting fluid under conditions described herein to wet the semipermeable material. Thereafter, the method may include exposing the semipermeable material to a second wetting step, wherein the semipermeable material is exposed to a second wetting fluid that is the same or different from the first wetting fluid. Any number of wetting steps may be performed (for example, one, or two, or three, or more), as desired. When more than one wetting step is contemplated, the wetting fluid of the various wetting steps can be the same, or different. In one embodiment, wetting the semipermeable material with the wetting fluid includes allowing a first wetting fluid (such as ethanol) to substantially soak into the porous regions of the semipermeable material. In some implementations, the semipermeable material is exposed to the first wetting fluid for a predetermined amount of time. Thereafter, wetting the semipermeable material may include a second wetting step, wherein the semipermeable material is exposed to a second wetting fluid (such as heptanol) under conditions sufficient to allow the second wetting fluid to substantially soak into the porous regions of the semipermeable material.

In some implementations, wetting the semipermeable material can include initially substantially filling the pores of the semipermeable material with ethanol, and replacing the intercalated ethanol with a second wetting fluid. The second wetting fluid can comprise ethanol or an alcohol that is different from ethanol. In some implementations, steps of initially substantially filling the pores of the semipermeable material with ethanol can assist in removing residual contamination and/or residual water within the semipermeable material.

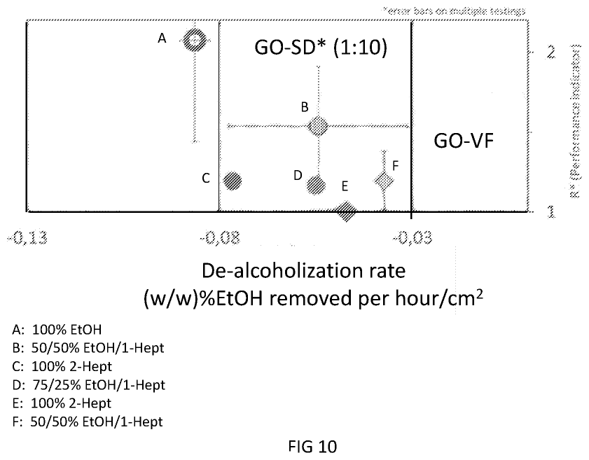

FIG. 10 illustrates dealcoholization performance of GO membranes deposited using vacuum filtration (GO-VF) and slot die coating (GO-SD) when wetted with various wetting fluids, including 100% ethanol (100% EtOH), mixtures of ethanol and heptanol in different proportions (50/50% and 75/25% EtOH/1-heptanol), 100% heptanol (100% 2-heptanol). As shown in FIG. 10, GO based membranes treated with 100% heptanol as wetting fluid exhibited desirable separation properties (R*=1.003 and dealcoholization rate=−0.07 (w/w) % EtOH/hrs/cm²).

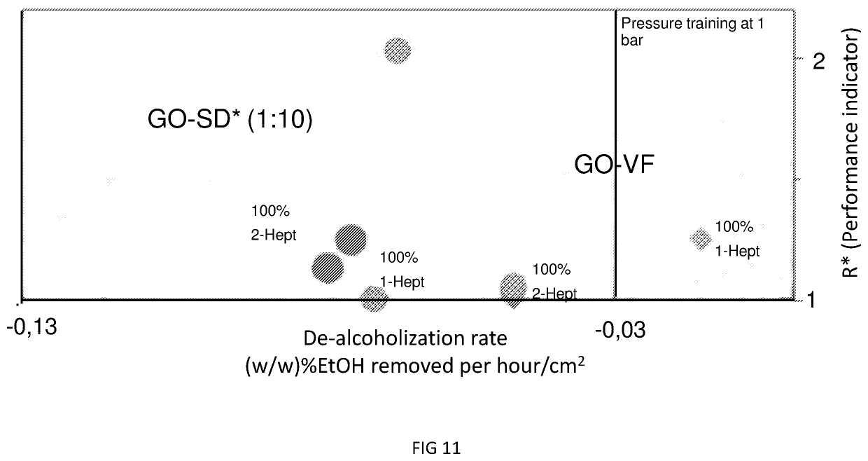

FIG. 11 illustrates dealcoholization performance of GO based membranes deposited using vacuum filtration (GO-VF) and slot die coating (GO-SD) when wetted with various wetting fluids, including 100% 2-heptanol (solid circles) and 100% 1-heptanol (hashed circles).

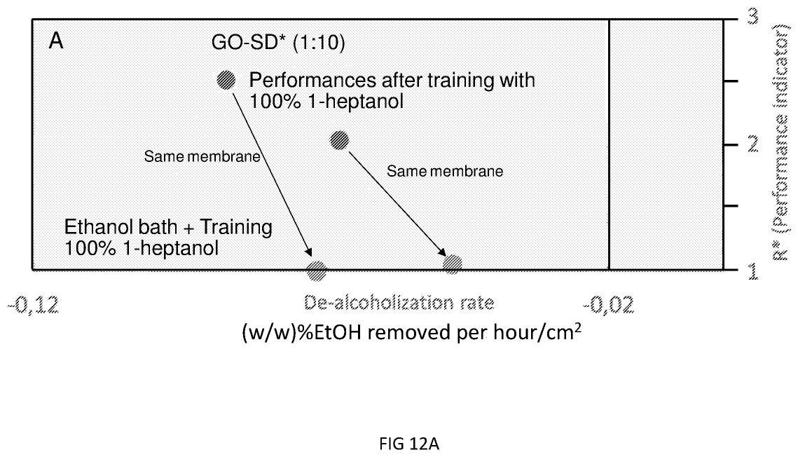

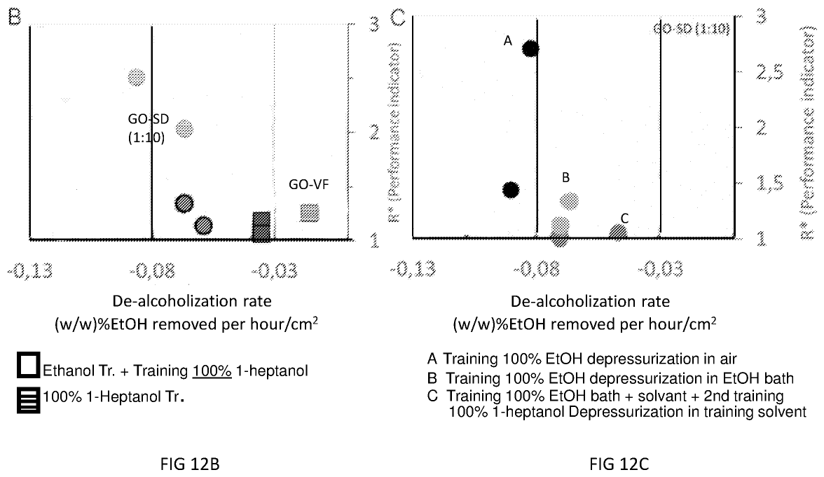

FIG. 12A-12C illustrate GO membranes that were subjected to single-step and multiple-step wetting processes. For all membranes shown in FIGS. 12A-12C, single-step wetting was accomplished using a ethanol solution only, while multiple step wetting was accomplished by a first ethanol wetting step, followed by wetting with 100% 1-heptanol. In FIG. 12A, GO membranes prepared by slot-die methods were assessed for ethanol separation performance before and after wetting. Membranes exhibited improved selectivity for ethanol after wetting in a first stage with ethanol, followed by a second step of training with 1-heptanol (100%). FIG. 12B illustrates a comparison of single (hashed shapes) versus multiple-step wetting (solid shapes). Single-step wetting involved exposure of the GO membranes to a 100% 1-heptanol fluid. Multiple-step wetting involved exposure of the GO membranes to ethanol, followed by exposure of the membranes to 100% 1-heptanol. In FIG. 12C, GO membranes were subjected to a depressurization step. After the membrane was saturated with wetting fluid, the membrane was placed in a low vacuum environment. Results illustrate that in some embodiments, a multiple step wetting process can improve a membrane's ability to separate ethanol from a feed solution. Results illustrate that in some aspects, subjecting wetted membranes to a low vacuum environment can improve a membrane's ability to separate ethanol from a feed solution.

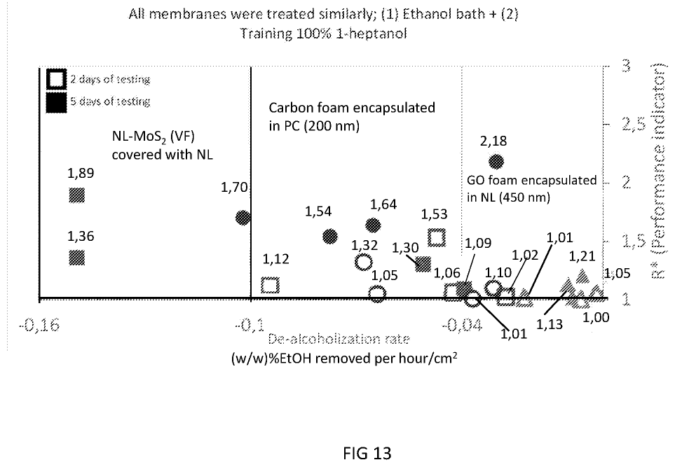

FIG. 13 shows dealcoholization performances of various semipermeable material structures. MoS₂ membranes deposited onto a Nylon substrate (vacuum filtration deposition) are illustrated in squares within the figure (NL-MoS₂ (VF)), commercial carbon foam encapsulated between two polycarbonate substrates (200 nm) is shown in circles, GO foams encapsulated between two nylon substrates (NL, 450 nm) is shown in triangles, and GO deposited onto nylon using vacuum filtration (NL-GO (VF) squares to the right side of the figure). Performances after two days are shown with open shapes, and five days with filled shapes. All membranes were trained similarly using two steps: (1) ethanol bath for one night, and (2) vacuum.

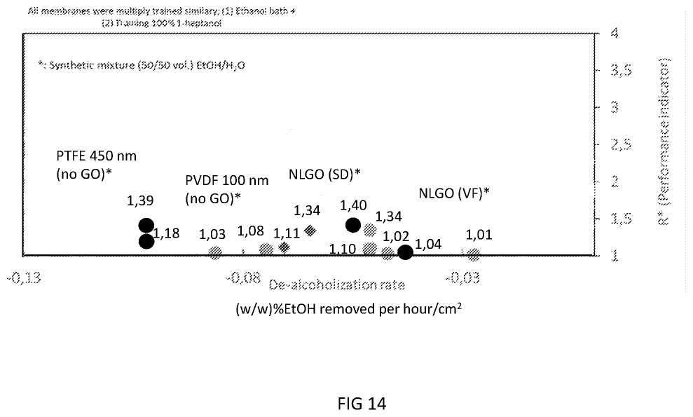

In accordance with some implementations, various macroporous semipermeable materials can be utilized for ethanol separation. FIG. 14 illustrates performances of various commercial macroporous substrates compared to GO-supported membranes. Data includes PVDF membranes with a pore size of 100 nm (PVDF 100 nm (no GO)), PTFE membranes with a pore size of 450 nm (PTFE 450 nm (no GO)), graphene oxide deposited onto nylon using vacuum filtration (NLGO (VF)), and graphene oxide deposited onto nylon using slot-die processes (NLGO (SD)). Data showed that PDVF membranes with a pore size of 100 nm exhibited an R* of 1.01 and dealcoholization rate of −0.16 (w/w %) EtOH/h/cm², and PTFE with a pore size of 450 nm exhibited an R* value of 1.00 and dealcoholization rate of −0.007 (w/w %) EtOH/h/cm².

After the semipermeable material is wetted with the wetting fluid, excess wetting fluid (e.g., fluid not contained within the semipermeable material) can be removed from at least part of the filtration system. In some implementations, the wetting fluid should remain present within the semipermeable material so that the semipermeable material retains a preference for a second organic compound to be removed from a second liquid. In some implementations, the surfaces of the semipermeable material remain wet with the wetting fluid while adding the second fluid and the third fluid, as is discussed below. In some implementations, the semipermeable material remains in a sealing position between the feed vessel and the draw vessel. It should be appreciated that in some implementations, the sealing position between the feed vessel and the draw vessel means that fluid leaks do not occur between the vessels except through the semipermeable material. In some implementations, a wetted semipermeable material is placed in a sealing position between a new feed vessel and a new draw vessel.

In some implementations, the semipermeable material (such as a membrane) is wetted inline within a filtration machine. For example, the unwetted (untrained) semipermeable material can be installed in a filtration machine to be used to remove or separate ethanol from a liquid. The wetting fluid is then introduced into the filtration machine, under conditions described elsewhere herein as suitable for wetting. Once the semipermeable material is suitably wetted with the wetting fluid, the filtration device can simply be used for the separation process, without having to move or manipulate the semipermeable material.

In some implementations, the semipermeable material can be periodically wetted with the wetting fluid while installed in the filtration machine (e.g., inline re-wetting). For example, the semipermeable material can be utilized in a desired number of filtration/removal sequences until such time as the efficacy of the semipermeable material begins to decline. The filtration machine can then be drained of the second and third fluids, and the wetting fluid can be introduced into the machine to re-wet (re-train) the semipermeable material under wetting conditions described elsewhere herein. In some implementations, re-wetting the semipermeable material can be performed any number of times, so long as the integrity of the semipermeable material is maintained for the separation process.

In some implementations, the system can be depressurized (e.g., by applying a low vacuum) after the semipermeable material has been wetted. In some implementations, such depressurization can reduce the presence of residual intercalated water in the semipermeable material. In some implementations, depressurization can be performed in the presence of the wetting fluid.

Once wetting of the membrane has taken place, the product is a semipermeable membrane that contains wetting fluid. In some implementations, wetting fluid is stably contained within pores of the semipermeable material. In some implementations, wetting fluid is maintained within pores of the semipermeable material in a manner that resists leaching out of the semipermeable material. FIGS. 4A, 4B, and 4C illustrate GOM having wetting fluid contained within pores of the membrane. As illustrated in FIG. 4A, one implementation comprises a membrane 305 comprising substrate 310 and GO layer 320 in a sandwich format in which substrate layers 310 are included on each side of the GO layer 320 such that the substrate layers 310 will contact a second fluid during use of the membrane. As illustrated, substrate layer 310 can include pores having a diameter 330. Wetting fluid 340 is shown as contained within (e.g., entrapped within) pores of the substrate 310. As illustrated in FIG. 4B, one implementation comprises a membrane 305 comprising a sandwich format wherein GO layers 320 are located on either side of substrate 310. Wetting fluid 340 is shown as contained within (e.g., entrapped within) pores of the substrate 310. FIG. 4C illustrates a further implementation, wherein membrane 305 includes an alternating structure of layers consisting of GO layers 320/first substrate 310/second substrate 350/GO layers 320/first substrate 310. As shown, wetting fluid 340 can be contained within pores of the first substrate 310 and second substrate 350. As illustrated, pores of the first substrate 310 differ in diameter from pores of the second substrate 350. The membrane 305 shown includes a larger pore size in the second substrate 350. It is understood that the pore size can be the same or different from one substrate to another, as desired. In some implementations (not shown in the figures), wetting fluid can be contained within (e.g., entrapped within) pores in the GO layers. In some implementations, wetting fluid can be contained within pores in some or all of the individual layers of the GOM.

When the wetted semipermeable material will not be immediately used for separation of organic compounds, the wetted membrane, substrate, or membrane-substrate combination can be provided with a protective layer. Suitable protective layers can comprise polymer films, such as any of the polymers described herein. In some aspects, a protective polymer film can comprise Nylon or polycarbonate.

In some implementations, after the semipermeable material is wetted with a wetting fluid, it can be packaged for later usage in filtration processes. In some aspects, therefore, kits including pre-wetted semipermeable material can be provided. In some implementations, after the semipermeable material is wetted with a wetting fluid, the semipermeable material is removed from the filtration system and packaged. In some implementations, the wetting fluid should remain in the semipermeable material so that the semipermeable material retains a preference for a second organic compound to be removed from a second liquid.

In some implementations, a wetted semipermeable material comprises a GO membrane and wetting fluid contained within a package. In some implementations, the GO membrane comprises GO layers. In some aspects, wetting fluid is retained in pores within the GO membrane. In some implementations, the GO membrane comprises GO layers and one or more substates. In some implementations, wetting fluid is retained in pores within the GO layers and/or pores within the substrate(s). It will be readily appreciated any of the GO membranes described herein can be utilized in these aspects. In some implementations, a wetted semipermeable material comprises one or more substrates (e.g., without a membrane). In some aspects, wetting fluid is retained in pores within the substrate(s).

In some implementations, the wetted semipermeable material is packaged in a suitable material that is impermeable to gas and water vapor. In various implementations, the pre-wetted nanoporous material can be enclosed in opaque material, for example, when the nanoporous material is susceptible to light-induced alterations. In some implementations, packaging material can comprise foil, such as aluminum foil. In some implementations, packaging material can comprise multi-layers of foil and plastics. In some implementations, barrier resins such as ethylene/vinyl alcohol (EVAL) or a barrier coating such as polyamide (Nylon), polyvinyl alcohol (PVAL), polyvinylidene chloride (PVDC), metallized aluminum, silicon oxide (SiOₓ) or aluminum oxide (AlOₓ) can be included. Barrier packaging can be provided in the form of a pouch, vacuum-bag, tray, and the like. A barrier's performance can be measured by the Oxygen Transmission Rate (OTR) and the Water Vapor Transmission rate (WVTR) of the barrier material. The lower the transmission rate, the better the barrier performance. The ability level of a barrier is determined by the transmission of molecular gas (O₂, CO₂, N₂), water vapor, and other organic solvents. A barrier can consist of single layers, or multiple layers of films. In some implementations, barrier packaging can comprise multiple layers of materials, such as polyethylene terephthalate (PET) in conjunction with polyethylene or polypropylene. In some implementations, wetted semipermeable material is packaged with an amount of the wetting fluid. Optionally, packaged wetted semipermeable material can include structural elements to protect the physical integrity of the semipermeable material (e.g., membrane, substrate, or membrane-substrate combination). Such structural elements can be associated with the semipermeable material. In these aspects, structure elements such as protective material can be provided as an outer sandwich over the semipermeable material, and the outer protective material can be removed prior to use. In some implementations, structural elements can be included in the packaging to protect the physical integrity of the semipermeable material.

In some implementations, the pre-wetted semipermeable material can include an additional amount of “free” wetting liquid within the package. In this context, “free” wetting liquid refers to wetting liquid that is not retained within the wetted semipermeable material, but rather is added as a separate component to the packaging. In some implementations, providing free wetting liquid within the packaging can assist in stabilizing the wetted semipermeable material, for example, by maintaining the semipermeable material in a moist environment until use. Optionally, pre-wetted semipermeable material can include a protective layer as discussed elsewhere herein.

In some aspects, packaged pre-wetted semipermeable material can provide benefits in removal of organic compounds using separation methods described herein. In some implementations, pre-wetted GO membranes provide a ready-to-use filter for separation or removal of an organic compound. This can provide benefits, for example, by minimizing or avoiding the cost and labor involved in preparing the GO membranes. Packaged, pre-wetted semipermeable materials can be provided utilizing any of the wetting fluids, membranes, and/or substrates, and any formats, described herein. Similarly, packaged, pre-wetted semipermeable materials can be provided in any dimensions and configurations suitable for end-use.

In some implementations, pre-wetted semipermeable material can be installed in modules that can be installed as units in filtration machines. In some implementations, each module can include one or more pre-wetted semipermeable material as desired for a particular application and filter machine. For example, in some implementations, one or more pre-wetted semipermeable materials can be installed in a cassette or unit that is configured to be installed directly into a filtration machine. In some implementations, the modules can be removed, cleaned, and reinstalled for additional filtration applications.

In some implementations, a semipermeable material comprises a substrate that is wetted with a wetting fluid. In some implementations, a semipermeable material comprises one or more layers of substrate, and does not include carbon- or molybdenum-based membranes. Unexpectedly, it has been found that wetting the substrate with a wetting fluid comprising a first organic compound can cause the substrate to preferentially permit a second organic compound to more readily pass through the substrate when later exposed to other fluids that contain the second organic compound. In some implementations, wetting a substrate includes exposing the substrate to a wetting fluid including at least one first organic compound.

In some implementations, the semipermeable material comprises a substrate as discussed above. In some implementations, the substrate may comprise a polymer (organic or inorganic), or a metallic material. In some implementations, the one or more other materials may include one or more layers of an aerogel with a porous structure, which can provide structural support and/or create a mixing action near the surface of the semipermeable material while fluids flow across the surface of the semipermeable material.

In some implementations, a substrate can comprise a polymer layer or sheet. In some implementations, a polymer layer or sheet can comprise a polymer selected from polyamide (Nylon), polytetrafluoroethylene (PTFE, commonly referred to as Teflon®), polyethersulphone (PES), polycarbonate (PC), polyvinylidene fluoride (PVDF), polysulfone (PSF), polyvinyl chloride (PVC), and the like, or combinations or blends of any two or more of these. Other suitable polymers can include, for example, cellulose acetate (CA), polyimide (PI), polyacrylonitrile (PAN), polyethylene glycol (PEG), polyvinyl alcohol (PVA), polymethacrylic acid (PMAA), poly(arylene ether ketone) (PAEK), poly(ether imide) (PEI), and polyethersulfone amide (PESA), and the like, or combinations or blends of any two or more of these.

In some implementations, polymer layer (such as PTFE) can be laminated onto a netting or nonwoven backing (for example, polypropylene netting or nonwoven polypropylene backing), or unlaminated. In some implementations, substrate polymer can be hydrophobic. In some aspects, “hydrophobic” means a polymer that is non-polar in nature and is thus not soluble in water or other polar solvents. In some implementations, a polymer layer or sheet can include surface architecture. One suitable polymer layer including surface architecture comprises polycarbonate track etch (PCTE) membrane. In some implementations, a polymer sheet or layer can comprise a polyamide, such as Nylon.

In some implementations, a substrate can comprise metallic mesh, aluminum, alumina (aluminum oxide), copper, or active carbon.

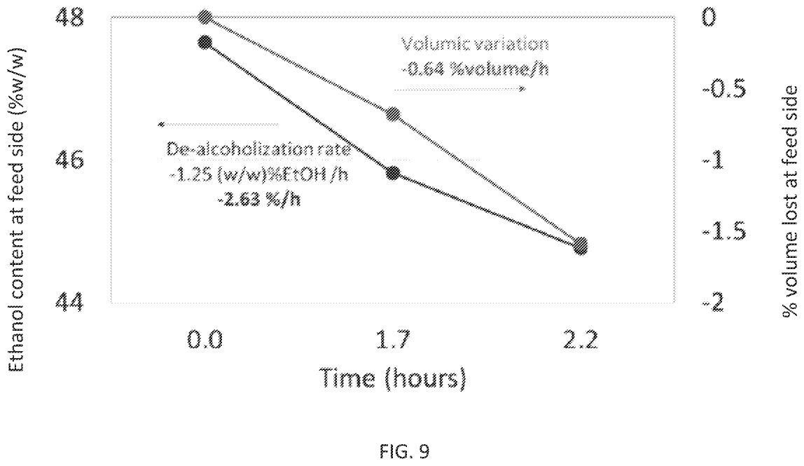

FIG. 9 illustrates removal of ethanol using a semipermeable material composed of Nylon (450 nm pore size) that is wetted with 2-heptanol. The Nylon substrate was wetted by exposing the membrane to a 10 ml solution of 50/50 (v/v %) heptan-2-ol in ethanol under pressure at 1 bar until the wetting fluid was observed to coat the other side of the substrate that was initially dry. The wetted Nylon substrate was then exposed to a feed solution of 10 ml of a synthetic solution composed of 50/50 (v/v %) ethanol in water. The draw solution was 300 ml pure water. Results shown in FIG. 9 indicate the wetted Nylon substrate provided significant ethanol reduction in the feed liquid.

In some implementations, semipermeable material can comprise a combination of membrane and substrate. For example, graphene oxide membranes were deposited on a Nylon substrate using vacuum filtration were wetted with several wetting fluids shown in Table 1. The resulting wetted membranes were used to separate ethanol from a synthetic mixture of 50% by volume of ethanol in water. Measurement of alcohol volume content was accomplished with an Anton Paar alcoholmeter. R* values were as follows:

TABLE 1
GO-NL semipermeable material

| Wetting Fluid | R* value |
|---|---|
| 100% ethanol | 1.09 |
| 100% butan-1-ol | 1.02 |
| 1-Heptanol | 1.25 |
| 2-Heptanol | 1.49 |

Returning to FIG. 2A, as shown in block 110, a first side of the semipermeable material (e.g., GOM) is exposed to a second fluid, where the second fluid includes at least one second organic compound. The second fluid includes an initial concentration of the at least one second organic compound. For example, a first side of the semipermeable material can be exposed to a second fluid that contains a plurality of compounds including, among other compounds, water and ethanol. In some implementations, the second fluid can be an alcoholic beverage (e.g., gin, whisky, vodka, wine, beer, etc.). For example, an alcoholic beverage can be placed in the feed vessel such that the alcoholic beverage is in physical contact with the first side of the semipermeable material.

In some implementations, the second fluid can be pretreated prior to the step shown in 110. For example, in some implementations the second fluid can be treated to concentrate the second organic compound. In some implementations, the second fluid is subjected to filtration or heat treatment to remove water (dehydrate) the second fluid, thereby concentrating the amount of the second organic compound in the fluid. In some implementations, a wine can be dehydrated to provide an elevated ethanol content, and the concentrated wine can be exposed to the first side of the semipermeable material as shown in block 110. In some implementations, a beer can be dehydrated to provide an elevated ethanol content, and the concentrated beer can be exposed to the first side of the semipermeable material as shown in block 110. In some implementations, dehydration can be applied to any alcoholic beverage to be treated in accordance with methods described herein.

In some implementations, the filtration process can include exposing a second side (e.g., the other side or draw vessel side) of the semipermeable material to a third fluid as shown in block 120. In some implementations, the second side of the semipermeable material can be exposed to a third fluid. In some implementations, the third fluid can be water. For example, water can be placed in the draw vessel such that the water is in physical contact with the second side of the semipermeable material. In some implementations, the water is purified water. In some implementations, the purified water is Milli-Q™ water. In some implementations, the water can be tap water. In some implementations, the water may include one or more additional compounds (e.g., salts or other minerals) that may enhance an osmotic flow of compounds between the feed vessel and the draw vessel through the semipermeable material. In some implementations, the third fluid is an alcoholic beverage in which the ethanol contents have been reduced by dealcholization. In some implementations, dealcoholization of the third fluid can be accomplished by one or more methods, including heat, vacuum distillation, and the like. In some implementations, the third fluid is an alcoholic beverage in which the ethanol contents have been at least partially removed through the filtration process described herein. It should be appreciated that block 120 may occur before, substantially simultaneously with, or after block 110.

In some implementations, block 120 can be performed in a cross-flow structure, where exposure can include moving fluid across a surface of the semipermeable material. For example, the third fluid can be injected with a pump (e.g., the pump can be internal or external to the draw vessel) into the draw vessel so that the third fluid flows tangentially across a second side of the semipermeable material. The third fluid may further be removed from the draw vessel after flowing tangentially across the second side of the semipermeable material. In some implementations, the third fluid may be pumped across the second side of the semipermeable material (and removed) one or more times, where each time creates a cycle. For example, if a liter of a third fluid is pumped across the second side of the semipermeable material and removed, the liter of the third fluid completed one cycle across the semipermeable material. If the same liter of the third fluid is pumped across the second side of the semipermeable material and removed a second time, the liter of the third fluid completed a second cycle across the semipermeable material. In some implementations, the third fluid may be cycled continuously across the second side of the semipermeable material. In some implementations, the third fluid may be cycled intermittently across the second of the semipermeable material. In some implementations, the flow of the third fluid across the second side of the semipermeable material is periodically stopped and restarted (within a cycle). In some implementations, the third fluid is pumped across the second side of the semipermeable material and removed and not cycled back across the second side of the semipermeable material. That is, in some implementations, fresh quantities of the third fluid are pumped across the second side of the semipermeable material and are not recycled across the semipermeable material.

In some implementations, at least a portion or substantially all air bubbles are prevented from forming on the second side of the semipermeable material by ensuring that the second side of the semipermeable material remains wet with the first fluid (e.g., the wetting fluid) before the third fluid is added to the draw vessel. In some implementations, when the second side of the semipermeable material is wet with the first fluid when the third fluid is added to the draw vessel, the physical interface between a third fluid and the second side of the semipermeable material remains substantially free of air bubbles. In some implementations, a substantially homogeneous third fluid and membrane interface (e.g., lacking air bubbles) can be particularly beneficial to maximizing the separation process that is described below.

In some implementations, as shown in block 130, the process includes causing a movement of the second fluid across the first side of the semipermeable material for a predetermined quantity of time. In some implementations, the movement of the second fluid across the first side of the semipermeable material includes applying a pressure to the second fluid within the feed vessel. In some implementations, the pressure can be 0.75 bars or less of pressure. In some implementations, the pressure can be above 0.75 bars. The predetermined quantity of time to continue movement of the second fluid may include 30 minutes, 1 hour, 8 hours, 24 hours, 48 hours, or some other suitable time period. In some implementations, the quantity of time relates to how much of the at least one compound in the second fluid is desired to be removed from the second fluid.

In some implementations, movement of the second fluid across the first side of the semipermeable material can be achieved, for example, using a pump, pressure (in combination with flow valves), gravity, and the like. For example, a pump can be included in the feed vessel. The pump may circulate the second fluid within the feed vessel, which in turn causes more of the second fluid to contact the first side of the semipermeable material. In some implementations, an aerator can be used with the filtration system. For example, an aerator can be used to induce a gas (e.g., an inert gas or other suitable gas) into the second fluid in the feed vessel to cause movement of second fluid within the feed vessel, which in turn causes more of the second fluid to contact the first side of the semipermeable material.

In some implementations, block 110 and 130 can be combined in a cross-flow structure. For example, the second fluid can be injected with a pump (e.g., the pump can be internal or external to the feed vessel) into the feed vessel so that the second fluid runs tangentially across the first side of the semipermeable material. The second fluid may further be removed from the feed vessel after running tangentially across the first side of the semipermeable material. In some implementations, the second fluid may be pumped across the first side of the semipermeable material (and removed) one or more times, where each time creates a cycle. For example, if a liter of a second fluid is pumped across the first side of the semipermeable material and removed, the liter of the second fluid completed one cycle across the semipermeable material. If the same liter of the second fluid is pumped across the first side of the semipermeable material and removed a second time, the liter of the second fluid completed a second cycle across the semipermeable material. In some implementations, the second fluid may be cycled continuously across the first side of the semipermeable material. In some implementations, the second fluid may be cycled intermittently across the first side of the semipermeable material. In some implementations, the flow of the second fluid across the first side of the semipermeable material is periodically stopped and restarted (within a cycle). In some implementations, the stopping and restarting aids in preventing or breaking a concentration or gel polarization layer that may form between the surface of the semipermeable material and the second fluid.

In some implementations using a cross-flow structure, the second fluid is pumped across the first side of the semipermeable material while the third fluid is pumped across the second side of the semipermeable material. In some implementations, the directional flow of the second fluid and the third fluid are the same. In some implementations, the directional flow of the second fluid and the third fluid are different (e.g., the flows can be in opposite directions). In some implementations, the rate that the third fluid is passed over the second side of the semipermeable material is in a range of 1× to 5× faster than the rate that the second fluid is passed over the first side of the semipermeable material. In some implementations, the rate is selected based on the type of liquid used for the second fluid. For example, when the second fluid includes a high concentration of ethanol and the ethanol needs to be selectively filtered, the rate of flow of the third fluid (e.g., water) should be kept high relative to rate of flow of the second fluid. In some implementations, a high concentration of ethanol in the second fluid that needs to be selectively filtered may cause the rate of flow of the third fluid to be selected at 5× the rate of flow of the second fluid. In some implementations, where the second fluid includes a high concentration of solids (e.g., wine or dark liquors), the flow rate of the third fluid may need to be reduced (e.g., 3×) relative to the rate of flow of the second fluid. In some implementations, where the second fluid includes a low concentration of ethanol that needs to be selectively filtered, the flow rate of the third fluid may need to be reduced (e.g., 2× or 1×) relative to the rate of flow of the second fluid. It should be appreciated that the rate of flow of the third fluid can be altered to a suitable flow rate. In some implementations, the rate of flow of the third fluid may be altered to compensate for variations based on the type of second fluid, volume of the second fluid on the semipermeable material, and/or flow rate of the second fluid.

It should be appreciated that one or more of the above mechanisms can be used in combination to cause movement of the second fluid across the first side of the semipermeable material. It should also be appreciated that other suitable mechanisms can be used to move the second fluid across the first side of the semipermeable material.

In some implementations, the process includes causing a movement of the third fluid across the second side of the semipermeable material for a predetermined quantity of time as noted above. In some implementations, when not using a cross-flow structure, movement of the third fluid across the second side of the semipermeable material can be achieved with a pump. In some implementations, a pump can be used to circulate the third fluid within the draw vessel, which in turn causes more of the third fluid to contact the second side of the semipermeable material. In some implementations, an aerator can be used on the draw side of the filtration system. For example, an aerator can be used to induce gas (e.g., an inert gas or other suitable gas) into the third fluid in the draw vessel to cause movement of third fluid within the draw vessel, which in turn causes more of the third fluid to contact the second side of the semipermeable material. In some implementations, movement of the third fluid across the second side of the semipermeable material can include physically moving the semipermeable material.

In some implementations, as shown in block 140, when the second fluid is in the feed vessel and in contact with one side (e.g., the first side) of the semipermeable material and the third fluid is in the draw vessel in contact with the other side (e.g., the second side) of the semipermeable material, permeation of the second organic compound through the semipermeable material causes the at least one second organic compound to be transferred from the second fluid to the third fluid through the semipermeable material. In some implementations, due to wetting the semipermeable material with the wetting fluid containing the at least one first organic compound, the at least one second organic compound contained in the second fluid is preferentially allowed to pass through the semipermeable material from the feed vessel to the draw vessel, to the exclusion of one or more other compounds in the second fluid. The preferential passage of the at least one second organic compound is unexpected especially in a situation where the second fluid comprises other compounds whose molecules are smaller than the at least one compound. In one example, where the wetting fluid is heptanol, heptanol comprises molecules that are larger than water. When the semipermeable material is not wetted, water and ethanol can pass through the semipermeable material, with a preference to water. However, in implementations when the semipermeable material is wetted with heptanol, the semipermeable material can preferentially or selectively allow ethanol molecules to pass through its porous structure, while blocking water molecules from passing through its porous structure. Thus, when an alcoholic beverage is added to the feed vessel, the semipermeable material permits ethanol to pass from the alcoholic beverage to the third fluid in the draw vessel while substantially blocking water and other compounds in the alcoholic beverage from passing through the semipermeable material.

In some implementations, the separation process can be aided by maintaining a temperature differential between the second fluid and the third fluid. In some implementations, the separation process can be further aided by adding one or more compounds to the third fluid (e.g., salt or other suitable compounds).

The separation process may be continued for any suitable period of time (e.g., cycling the second liquid and/or the third liquid across respective sides of the semipermeable material). The quantity of time to continue the separation process between the second fluid in the feed vessel and the third fluid in the draw vessel may comprise 15 minutes, 20 minutes, 30 minutes, 1 hour, 8 hours, 24 hours, 48 hours, or some other suitable time period. In some implementations, the quantity of time relates to how much of the at least one second organic compound in the second fluid is desired to be removed from the second fluid. In some implementations, the quantity of time relates to how much of the at least one second organic compound is contained within the second fluid. In some implementations, the quantity of time relates to the surface area used for the semipermeable material. In some implementations, a combination of factors can raise or lower the suitable period of time (e.g., a low percentage of ethanol in a feed vessel fluid in contact with a semipermeable material having 1 square meter area may require less time to remove an equivalent percentage of ethanol from a low percentage of ethanol in a feed vessel fluid in contact with a semipermeable material having 0.5 square meter area). In one example, when the second fluid includes 50% by volume of ethanol in water, after 24 hours the concentration of ethanol can be decreased and equalized close to 25% by volume of ethanol in the fluids on both sides of a GOM.

In one example, when beer is used as the second fluid in the feed vessel, a substantial portion of ethanol can be removed within 24 hours. Beer typically includes between 3%-7% of ethanol by volume. In another example, when a similar volume of gin or other distilled beverage is used as the second fluid in the feed vessel, a longer time is required for the separation process to remove a similar percentage of ethanol from the distilled beverage, where distilled beverages can range between 20%-95% of ethanol by volume. It should be appreciated that as part of the separation process, the preferentially treated at least one second organic compound attempts to equalize between the feed vessel fluid and the draw vessel fluid.

In some implementations, the draw vessel can be larger than the feed vessel, which allows the draw vessel to hold more of the third fluid by volume than the second fluid by volume in the feed vessel. In some implementations, maintaining a volume differential between the third fluid and the second fluid will cause more of the at least one second organic compound to flow from the second fluid to the third fluid during the separation process while equalizing the percentage of the at least one second organic compound between the second fluid and the third fluid. In some alternative implementations, the third fluid can be continuously replaced with fresh quantities of the third fluid to achieve a similar imbalance of the at least one second organic compound in the draw vessel, as is done by using a larger draw vessel with a larger quantity of the third fluid than the feed vessel with a smaller quantity of the second fluid.

In some implementations, as shown in block 150, the second fluid is recovered with at least a portion of the at least one second organic compound removed from the second fluid. In some implementations, the second fluid that is recovered at 150 is a dealcoholized fluid. The recovered second fluid (dealcoholized fluid) may have a final concentration of the at least one second organic compound that is between 0.5% and 100% less than the initial concentration, after completing the process outlined in FIG. 2A. It should be appreciated that one or more compounds may be passed from the second fluid to the third fluid through the semipermeable material during the separation process in some implementations.

In some implementations, a portion of the third fluid or draw fluid can be added back into the dealcoholized second fluid. For example, a portion of the third fluid or draw fluid can be added back when the draw fluid obtained one or more flavor compounds during the osmotic process. In another example, a portion of the third fluid or draw fluid can be added back where the final alcohol content of the dealcoholized second fluid is desired to be adjusted.

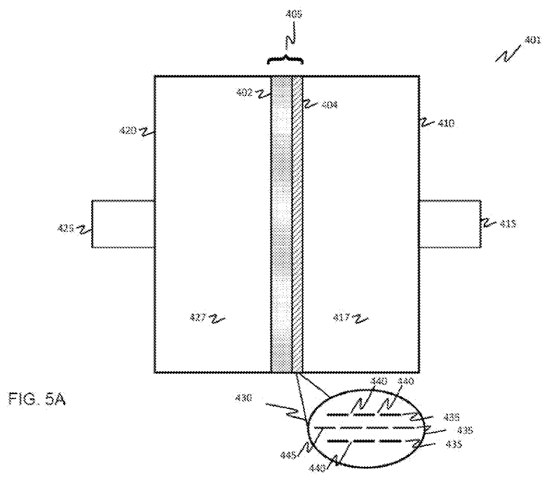

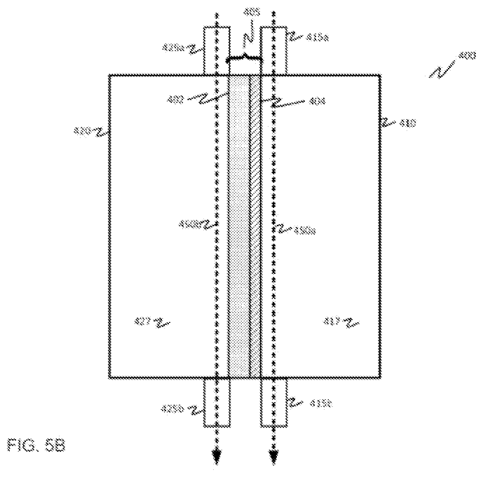

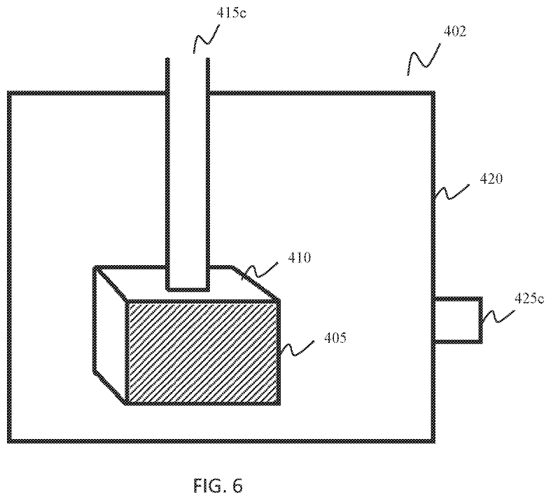

FIG. 5A shows one implementation of a cutaway of a filtering system 401. The filtering system includes a semipermeable material (e.g., a membrane) 405. In some implementations, the semipermeable material 405 may include the GOM as previously discussed or another suitable membrane, substrate, or membrane-substrate combination. In some implementations, the semipermeable material 405 includes a substrate layer 402 and a GO layer 404. It should be appreciated that GO layer 404 and other discussions of a GO layer may include one or more layers of GO that form part of a GOM. In some implementations, the substrate layer can be formed from polycarbonate. In some implementations, the filtering system may include a feed vessel 410. The feed vessel may include one or more inlets 415. It should be appreciated that the inlets can also serve as outlets. The feed vessel 410 may receive the wetting fluid discussed above through the one or more inlets 415. The feed vessel may also receive the second fluid 417 discussed above through the one or more inlets 415.

In some implementations, the filtering system 401 also includes a draw vessel 420. The draw vessel may include one or more outlets 425. It should be appreciated that the outlets can also serve as inlets. The draw vessel 420 may receive the wetting fluid passing through the semipermeable material 405. The draw vessel 420 may also receive the third fluid discussed above through the outlet 425. In some implementations, the draw vessel 420 may be larger than the feed vessel 410.

Reference 430 is an enlarged view of a small portion of the GO nanoporous structure. The GO may include one or more layers 435 of graphene flakes 445. The graphene flakes may include nanopores 440 of predetermined size that enable the semipermeable material 405 to preferentially permit at least one second organic compound in the second fluid 417 to pass through the semipermeable material 405 to the third fluid 427, while enabling one or more other compounds in the second fluid 417 to remain in the feed vessel 410.

In some implementations, the semipermeable material 405 creates a sealing interface between the feed vessel 410 and the draw vessel 420. The sealing interface between the two vessels does not allow fluid to pass between the feed vessel 410 and the draw vessel 420 except through the semipermeable material 405 in some implementations. It should be appreciated that while the semipermeable material 405 appears to span the width of the interface between the feed vessel 410 and the draw vessel 420, the semipermeable material 405 can be smaller than the width of the interface between the feed vessel 410 and the draw vessel 420.

For purposes of reference, the filtering system 401 can be used as discussed in connection with the filtering process described in FIG. 2A. As another shortened example of the method described in FIG. 2A, a wetting fluid (e.g., heptanol) can be added through the inlet 415 to the feed vessel 410. In some implementations, pressure can be applied to the wetting fluid through the inlet 415. In some implementations, a vacuum can also be applied to the outlet 425. The pressure on the wetting fluid and the vacuum on the draw vessel 420 will draw the wetting fluid through the semipermeable material 405. In some implementations, the wetting fluid is drawn through the semipermeable material 405 until the interface of the semipermeable material on the draw vessel side has a steady state flow of the wetting fluid. In some implementations, the wetting fluid is drawn through the semipermeable material 405 until the interface of the semipermeable material 405 on the draw vessel side is substantially wet with the wetting fluid.

In some implementations, excess wetting fluid can be removed from the feed vessel 410 and replaced with a second fluid (e.g., a fluid containing at least ethanol and water). The interface of the semipermeable material 405 on the feed vessel 410 should remain wet with the wetting fluid in some implementations. In some implementations, a third fluid (e.g., water) is also added to the draw vessel 420. In some implementations, the interface of the semipermeable material 405 on the draw vessel 420 should remain wet with the wetting fluid when adding the third fluid. In some implementations, excess wetting fluid does not necessarily need to be removed from the draw vessel 420. In some implementations, excess wetting fluid is removed from the draw vessel 420 before adding the third fluid.

In some implementations, osmotic pressure causes the at least one second organic compound in the second fluid in the feed vessel 410 to be drawn through the semipermeable material 405 into third fluid in the draw vessel 420. In some implementations, the second fluid in the feed vessel 410 is moved within the feed vessel 410. In some implementations, a pressure is applied through the inlet 415 (e.g., using a gas) to the second fluid. As will be shown in other figures, alternative implementations may include a circulation pump in place of the added pressure or in combination with the added pressure. It should be appreciated that in some implementations, movement and/or pressure does not need to be applied to the second fluid for the osmotic process to work. However, in some implementations, the separation process may plateau or stall when the movement of the second fluid is not induced across the interface of the feed vessel with the semipermeable material 405. After a suitable period of time (e.g., when a sufficient quantity of the at least one second organic compound is separated/removed from the second fluid), the second fluid that is separated from at least a portion of the at least one second organic compound can be recovered from the feed vessel 410. In some implementations, the second fluid can be recovered through the inlet 415 or some other suitable interface. In some implementations, the recovered second fluid is a dealcoholized fluid.

In some implementations, when the filtering system 400 is used with the process described in FIG. 2A on an alcoholic beverage, the semipermeable material (e.g., GOM) can selectively remove compounds such as ethanol from an alcoholic beverage. In some implementations, the ethanol by volume can be at least partially reduced from an alcoholic beverage. In some implementations, the ethanol by volume can be substantially reduced from an alcoholic beverage. Because the semipermeable material can selectively separate ethanol from an alcoholic beverage without heating the alcoholic beverage and without altering the process of making the alcoholic beverage (e.g., whether by brewing, fermentation, or by distillation), the ethanol content can be reduced or removed from the alcoholic beverage without a discernable change in the flavor profile in some implementations. In some implementations, the filtering system 400 can be used at any desirable point during formulation of an alcoholic beverage, for example, during brewing or distilling, or after the beverage has been fully prepared.

FIG. 5B shows one implementation of a cutaway of an alternative filtering system 400 implementing a cross-flow configuration from the filtering system illustrated in FIG. 5A. Many elements of FIG. 5B are the same as elements in FIG. 5A and will be referred to using the same reference numbers. In a cross-flow configuration, the feed fluid and draw fluid are moved tangentially across different sides of the semipermeable material (e.g., GOM). The filtering system includes a semipermeable material 405. In some implementations, the semipermeable material 405 may include the GOM as previously discussed or another suitable membrane, substrate, or membrane-substrate combination. In some implementations, the semipermeable material 405 includes a substrate layer 402 and a GO layer 404 (e.g., one or more layers of GO or GO flakes). In some implementations, semipermeable material 405 includes GO layer 404 without a substrate layer 402. In some implementations, one or more additional layers may be included in semipermeable material 405. For example, as discussed above, an aerogel layer or another material can be included on GO layer 404 to create a mixing action as feed fluid is pushed across the surface of the GO layer 404. In some implementations, the material to create the mixing action of the feed fluid can be formed on the surface of the GO layer 404 as spacers. In some implementations, the substrate layer can be formed from polycarbonate.

In some implementations, the filtering system may include a feed vessel 410. The feed vessel may include one or more inlets 415a. The feed vessel may include one or more outlets 415b. It should be appreciated that the inlets can also serve as outlets and outlets can serve as inlets. The feed vessel 410 may receive the second fluid 417 discussed above through the one or more inlets 415a. In some implementations, a pump (not shown) may push the second fluid 417 through an inlet 415a and tangentially across the surface of the GO layer 404 of semipermeable material 405. The second fluid 417 may exit the feed vessel 410 through one or more outlets 415b. In some implementations, the pump or some other mechanism may be used to add pressure to the second fluid 417 or pressure to the feed vessel 410 such that pressure is placed on the second fluid 417 as it flows across the surface of the GO layer 404.

In some implementations, the filtering system 400 also includes a draw vessel 420. In some implementations, the draw vessel may include one or more inlets 425a. In some implementations, the draw vessel may include one or more outlets 425b. It should be appreciated that the outlets can also serve as inlets and the inlets can serve as outlets. The draw vessel 420 may receive the third fluid 427 discussed above through the one or more inlets 425a. In some implementations, a pump (not shown) may push the third fluid 427 through an inlet 425a and tangentially across the surface of the substrate layer 402 of semipermeable material 405. The third fluid 427 may exit the draw vessel 420 through one or more outlets 425b. In some implementations, the draw vessel 420 may be larger than the feed vessel 410. In some implementations, the draw vessel 420 may be smaller than the feed vessel 410. In some implementations, the draw vessel 420 and the feed vessel 410 may be the same size or substantially the same size.

In some implementations, the semipermeable material 405 is sandwiched between the feed vessel 410 and the draw vessel 420 to create a sealing interface between the two vessels. The sealing interface between the two vessels does not allow fluid to pass between the feed vessel 410 and the draw vessel 420 except through the semipermeable material 405 in some implementations. It should be appreciated that while the semipermeable material 405 appears to span the width of the interface between the feed vessel 410 and the draw vessel 420, the semipermeable material 405 can be smaller than the width of the interface between the feed vessel 410 and the draw vessel 420.

In some implementations, before the semipermeable material 405 is placed between the feed vessel 410 and the draw vessel 420, one or more layers of wetting fluid are misted or atomized on one side of the semipermeable material 405 to wet the semipermeable material for selectivity of a particular compound. For example, one or more layers of wetting fluid are misted or atomized on the GO layer 404 as discussed above in connection with FIG. 2A (e.g., until the semipermeable material 405 is sufficiently wetted with the wetting fluid to selectively filter one or more second organic compounds that are different from the organic compound contained in the wetting fluid). In some implementations, the semipermeable material 405 can be wetted with the misting or atomization process while sandwiched between the feed vessel 410 and the draw vessel 420.

For purposes of reference, the filtering system 400 can be used as discussed in connection with the filtering process described in FIG. 2A. As another shortened example of the method described in FIG. 2A, one or more layers of a wetting fluid (e.g., heptanol) can be atomized over the surface of the GO layer 404 of the semipermeable material 405. In some implementations, pressure can be applied to the feed vessel 410 to help pass the misted or atomized wetting fluid through the semipermeable material 405. In some implementations, a vacuum can also be applied to the draw vessel 420 that may further help pass the misted or atomized wetting fluid from one side of the semipermeable material 405 to the other. In some implementations, the wetting fluid is applied to semipermeable material 405 until the interface of the semipermeable material is sufficiently saturated with the wetting fluid. In some implementations, for example, wetting fluid is misted or atomized on the GO layer 404 until the interface of the semipermeable material 405 on the draw vessel side is substantially wet with the wetting fluid.

In some implementations, excess wetting fluid can be removed from the surface of the GO layer 404. The interface of the semipermeable material 405 on the feed vessel 410 should remain wet with the wetting fluid in some implementations. In some implementations, a second fluid 417 (e.g., a fluid containing at least ethanol and water) is pumped across the GO layer 404 of the semipermeable material 405 in the feed vessel 410 through inlet 415a as shown by directional arrow 450a. In some implementations, the second fluid 417 exits the feed vessel 410 through outlet 415b as shown by direction arrow 450a. In some implementations, a third fluid 427 (e.g., water) is pumped across the substrate layer 402 of the semipermeable material 405 in the draw vessel 420 through inlet 425a as shown by directional arrow 450b. In some implementations, the third fluid 427 exits the draw vessel 420 through outlet 425b as shown by directional arrow 450b. In some implementations, the interface of the semipermeable material 405 on the draw vessel 420 should remain wet with the wetting fluid when adding the third fluid. In some implementations, excess wetting fluid does not necessarily need to be removed from the surface of the substrate layer 402 in the draw vessel 420 because the flow of the third fluid 427 may remove the excess wetting fluid. In some implementations, excess wetting fluid is removed from the draw vessel 420 before the third fluid is pumped across the surface of the substrate layer 402. It should be appreciated that flow rates and flow directions of the second and third fluids may vary as discussed above in connection with FIG. 2A.

It should also be appreciated that the flow of either the second fluid 417 and/or the third fluid 427 can be periodically stopped and restarted. This may help break up or reduce clogging of the GOM by suspended residues or the occurrence of a concentration or gel polarization layer from building up on the GO layer 404 side of the semipermeable material 405. In some implementations, the stopping and restarting of the fluid flows can be accomplished with short or long pulsed flow. In some implementations, vibrations (ultrasonic or otherwise) can be introduced to the flowing fluids to help break up or reduce clogging of the GOM by suspended residues or the occurrence of a concentration or gel polarization layer from building up on the GO layer 404 side of the semipermeable material 405. In some implementations, the flow of the second fluid can be temporarily reversed to help break up or reduce clogging of the GOM by suspended residues or the occurrence of a concentration or gel polarization layer from building up on the GO layer 404 side of the semipermeable material 405 (e.g., backwashing the second fluid). One or more of these methods can be utilized alone or in combination to help keep the GOM performing at an acceptable level.

FIG. 8 illustrates effect of stopping and restarting the fluid flows in some implementations. In these aspects, a membrane comprising a three-layer structure of Nylon/GO layers (1 μm thick)/PC was utilized to filter ethanol. The polycarbonate (PC) was included as a protective layer. Vapor wetting was performed by exposing the membrane to ethanol vapor under vacuum at 40° C. for one hour. As illustrated, the initial rate of ethanol removal began to slow within the first hour of the process. However, after a 30-minute pause in movement of the fluids across the membrane, the rate of ethanol removal resumed a more rapid rate.

In some implementations, forward osmotic pressure can cause the at least one second organic compound in the second fluid 417 pumped across the surface of the GO layer 404 in the feed vessel 410 to be drawn through the semipermeable material 405 into the third fluid 427 that is pumped across the substrate layer 402 in the draw vessel 420. After a suitable period of time (e.g., after one or more cycles of pumping the second and third fluid through the respective vessels and/or when a sufficient quantity of the at least one second organic compound is separated/removed from the second fluid, etc.), the second fluid 417 that is separated from at least a portion of the at least one second organic compound can be recovered. The second fluid 417 with at least a portion or all of the at least one second organic compound removed can be recovered from the outlet 415b. In some implementations, the recovered second fluid comprises a dealcoholized fluid.

FIG. 6 shows one implementation of a cutaway of a filtering system 402. Many elements of FIG. 5B are the same as elements in FIG. 5A and will be referred to using the same reference numbers. The filtering system 402 comprises a configuration in which one vessel is contained within another vessel. For example, as illustrated in FIG. 6, in some implementations, feed vessel 410 is contained within draw vessel 420. In some implementations, the feed vessel 410 includes a semipermeable material 405 on one or more sides of the feed vessel 410. It will be readily appreciated that FIG. 6 illustrates a feed vessel 410 having a semipermeable material 405 on only one side; however, any one or more sides of the feed vessel 410 can be configured to include a semipermeable material 405. In some implementations, feed vessel 410 can include a semipermeable material 405 on one side, or two sides, or three sides, or four sides, or five sides, or all sides of the vessel. In some implementations, the semipermeable material 405 may include the GOM as previously discussed or another suitable membrane. In some implementations, the semipermeable material 405 includes a substrate layer and a GO layer. It should be appreciated that GO layer and other discussions of a GO layer may include one or more layers of GO that form part of a GOM. In some implementations, the substrate layer can be formed from polycarbonate. The feed vessel may include one or more inlets 415c. It should be appreciated that the inlets can also serve as outlets. The feed vessel 410 may receive the wetting fluid discussed above through the one or more inlets 415c. The feed vessel may also receive the second fluid 417 discussed above through the one or more inlets 415c.

In some implementations, the filtering system 402 also includes a draw vessel 420. The draw vessel may include one or more outlets 425c. It should be appreciated that the outlets can also serve as inlets. The draw vessel 420 may receive the wetting fluid passing through the semipermeable material 405. The draw vessel 420 may also receive the third fluid discussed above through the outlet 425c.

In some implementations, the semipermeable material 405 creates a sealing interface between the feed vessel 410 and the draw vessel 420. The sealing interface between the two vessels does not allow fluid to pass between the feed vessel 410 and the draw vessel 420 except through the semipermeable material 405 in some implementations. It should be appreciated that while the semipermeable material 405 appears to span the width of the interface between the feed vessel 410 and the draw vessel 420 on a side of the feed vessel 410, the semipermeable material 405 can be smaller than the width of the interface between the feed vessel 410 and the draw vessel 420 on a side of the feed vessel 410.

For purposes of reference, the filtering system 402 can be used as discussed in connection with the filtering process described in FIG. 2A. As another shortened example of the method described in FIG. 2A, a wetting fluid (e.g., heptanol) can be added through the inlet 415c to the feed vessel 410. In some implementations, pressure can be applied to the wetting fluid through the inlet 415c. In some implementations, a vacuum can also be applied to the outlet 425c. The pressure on the wetting fluid and the vacuum on the draw vessel 420 will draw the wetting fluid through the semipermeable material 405. In some implementations, the wetting fluid is drawn through the semipermeable material 405 until the interface of the GOM on the draw vessel side has a steady state flow of the wetting fluid. In some implementations, the wetting fluid is drawn through the semipermeable material 405 until the interface of the semipermeable material 405 on the draw vessel side is substantially wet with the wetting fluid.

In some implementations, excess wetting fluid can be removed from the feed vessel 410 and replaced with a second fluid (e.g., a fluid containing at least ethanol and water). The interface of the semipermeable material 405 on the feed vessel 410 should remain wet with the wetting fluid in some implementations. In some implementations, a third fluid (e.g., water) is also added to the draw vessel 420. In some implementations, the interface of the semipermeable material 405 on the draw vessel 420 should remain wet with the wetting fluid when adding the third fluid. In some implementations, excess wetting fluid does not necessarily need to be removed from the draw vessel 420. In some implementations, excess wetting fluid is removed from the draw vessel 420 before adding the third fluid.

In some implementations, osmotic pressure can cause the at least one second organic compound in the second fluid in the feed vessel 410 to be drawn through the semipermeable material 405 into third fluid in the draw vessel 420. In some implementations, the second fluid in the feed vessel 410 is moved within the feed vessel 410. In some implementations, a pressure is applied through the inlet 415c (e.g., using a gas) to the second fluid. As will be shown in other figures, alternative implementations may include a circulation pump in place of the added pressure or in combination with the added pressure. It should be appreciated that in some implementations, movement and/or pressure does not need to be applied to the second fluid for the osmotic process to work. However, in some implementations, the osmotic process may plateau or stall when the movement of the second fluid is not induced across the interface of the feed vessel with the semipermeable material 405. After a suitable period of time (e.g., when a sufficient quantity of the at least one second organic compound is separated/removed from the second fluid), the second fluid that is separated from at least a portion of the at least one second organic compound can be recovered from the feed vessel 410. In some implementations, the second fluid can be recovered through the inlet 415c or some other suitable interface. In some implementations, the recovered second fluid is a dealcoholized fluid.

In some implementations, when the filtering system 402 is used with the process described in FIG. 2A on an alcoholic beverage, the nanoporous GOM can selectively remove compounds such as ethanol from an alcoholic beverage. In some implementations, the ethanol by volume can be at least partially reduced from an alcoholic beverage. In some implementations, the ethanol by volume can be substantially reduced from an alcoholic beverage. Because the GOM can selectively separate ethanol from an alcoholic beverage without heating the alcoholic beverage and without altering the process of making the alcoholic beverage (e.g., whether by brewing, fermentation, or by distillation), the ethanol content can be reduced or removed from the alcoholic beverage without a discernable change in the flavor profile in some implementations. In some implementations, the filtering system 400 can be used at any desirable point during formulation of an alcoholic beverage, for example, during brewing or distilling, or after the beverage has been fully prepared.

In some implementations, the contained configuration illustrated in FIG. 6 can be included inline in a beverage processing machine. For example, the filtration system 402 illustrated in FIG. 6 can be included inline within the production process for a beverage, such as an alcoholic beverage. In some implementations, the contained configuration illustrated in FIG. 6 can utilize concepts of the cross flow configuration illustrated in FIG. 5B.

In some implementations, when the filtering system 400, 401 or 402 is used with the process described in FIG. 2A on an alcoholic beverage, the nanoporous GOM can selectively remove compounds such as ethanol from an alcoholic beverage. In some implementations, the ethanol by volume can be at least partially reduced from an alcoholic beverage. In some implementations, the ethanol by volume can be substantially reduced from an alcoholic beverage. Because the GOM can selectively separate ethanol from an alcoholic beverage without heating the alcoholic beverage and without altering the process of making the alcoholic beverage (e.g., whether by brewing, fermentation, or by distillation), the ethanol content can be reduced or removed from the alcoholic beverage without a discernable change in the flavor profile in some implementations.

In some implementations, separation methods can include reclamation or reuse processes. In some aspects, such processes can reduce water and energy usage. Some illustrative features of these aspects will now be described in more detail.

In some implementations, the third fluid (draw fluid) can be further utilized once the second compound has permeated the membrane and transferred to the third fluid. Referring to FIG. 2B, in some implementations, as shown in block 160, the third fluid is recovered with at least a portion of the at least one second organic compound transferred from the second fluid. In some implementations, this recovered third fluid can be moved through the draw fluid side 420 of the system in a continuous manner, for example, when the filtration system 400 or 401 is provided in a closed-loop system. In some implementations, this recovered third fluid can be diverted from the filtration system 400 or 401 and collected in a draw fluid collector (not shown). It should be appreciated that one or more compounds may be passed from the second fluid to the third fluid through the GOM during the separation process in some implementations.

In some implementations, the recovered third fluid collected in the draw fluid collector can be used as a wetting fluid for a membrane, as described elsewhere herein. In various aspects, reclamation of the recovered third fluid removed from the draw vessel can provide a beneficial wetting fluid for additional filtration and can reduce the amount of water required to perform filtration processes as described herein. In some implementations, reclamation systems can be provided in open-loop or closed-loop configurations within the systems described herein.

In some implementations, the recovered third fluid can be removed from the draw vessel and subsequently used to create a beverage. For example, when the second organic compound is ethanol, the recovered third fluid comprises an ethanol/water mixture. This ethanol/water mixture can be utilized to create new beverages, for example, it can be combined with additional ingredients to create a beverage, such as carbonation to create a seltzer, and/or flavorings to create an alcoholic beverage. In some implementations, the recovered third fluid can be collected and combined with the dealcoholized second fluid at 150, to fine tune the alcohol content of the beverage.

In some implementations, the recovered third fluid can be further processed as illustrated in FIG. 2B. In some implementations, the third fluid can be subjected to further dealcoholization 170 to reduce the alcohol content in the third fluid. In these aspects, the dealcoholized third fluid from 170 can be reused in a filtration process and can assist in maintaining an osmotic pressure in the system. In some implementations, the third fluid can be dehydrated as illustrated at 180. In some implementations, the second fluid is subjected to filtration or heat treatment to remove water (dehydrate) the second fluid, thereby concentrating the amount of the second organic compound in the fluid. In some aspects, water reclaimed from dehydration at 180 can be reused in a filtration method as shown in FIG. 2A or 2B. A concentrated second organic compound resulting from 180 can be used to adjust a final alcohol content in a beverage as discussed in more detail below.

In some implementations, the various methods and apparatuses can be used to create customized beverages. For example, when the methods and apparatuses are used to dealcoholize beverages, a recovered dealcoholized fluid obtained from feed vessel 410 can contain a reduced alcohol content X. Similarly, a recovered third fluid obtained from draw vessel 420 can contain an alcohol content Y. The recovered dealcoholized fluid can be combined with the recovered third fluid to provide a final beverage having an alcohol content Z that is between X and Y. In this manner, the alcohol content of a final beverage can be fine-tuned as desired. In a similar manner, a recovered third fluid obtained from draw vessel 420 can include other compounds in addition to the removed second organic compound (such as compounds affecting organoleptic properties such as aroma, mouthfeel and flavor). In some implementations, adding back an amount of a recovered third fluid to a dealcoholized fluid can adjust organoleptic properties of the final beverage as desired.

In some implementations, a dealcoholized fluid produced in accordance with methods and apparatuses described herein can be blended with one or more recovered third fluids obtained from draw vessel 420, to provide the ability to adjust features of the final beverage.

It should therefore be appreciated that the various methods and apparatuses discussed herein, when applied to alcoholic beverages, enables the production of dealcoholized, low alcohol, or substantially non-alcoholic beverages that taste like their traditional alcoholic beverage counterparts. In some implementations, the methods and apparatuses discussed herein enable ethanol or ethyl alcohol to be substantially removed from an alcoholic beverage while substantially preventing other compounds from being removed from the alcoholic beverage. The resulting beverage can either contain low alcohol or substantially no alcohol, while retaining many or most of the compounds that give the original alcoholic beverage its signature taste. For example, if the methods and apparatuses discussed herein are applied to a brewed alcoholic beverage (e.g., a stout beer) to produce an altered stout beer, the altered stout beer continues to taste like the stout beer, while the altered stout beer has low or substantially no alcohol. As another example, if the methods and apparatuses discussed herein are applied to a distilled spirit like gin, the altered gin continues to taste like the original gin, while the altered gin has low or substantially no alcohol. In other words, in some implementations, the novel methods and apparatuses discussed herein can produce a low alcohol or non-alcoholic beverage that tastes the same or very similar to their alcoholic counterparts and can mimic or substitute for traditional alcoholic beverages. In some implementations, the methods and apparatuses discussed herein can be applied to other beverages or human consumable items. For example, if a lactating mother consumed alcohol, the milk the mother produces may contain alcohol. Previously, such a lactating mother would be forced to throw out any milk contaminated with alcohol. When the mother's milk is applied to the various methods and apparatuses noted above, the mother milk can have the alcohol contamination removed from the milk and enable the milk to be provided to the mother's nursing child. As another example, the methods and apparatuses discussed herein can be applied to tinctures (e.g., a solution that has ethanol as its solvent). In some implementations, a tincture can be an extract of plant or animal material dissolved in ethanol. Solvent concentrations of ethanol in the tinctures can typically range between 25-60%. In some implementations, the solvent concentrations of ethanol can run as high as 90%. The various methods and apparatuses discussed herein can be applied to such tinctures to remove the ethanol, while substantially retaining the extract without the alcohol. As yet another example, some consumable food products like flavoring (e.g., vanilla flavoring) or cannabis extracts are stored in an alcohol-based solution. The various methods and apparatuses discussed herein can be applied to such consumable products to remove the alcohol, while retaining the consumable item. Removing alcohol from such consumable items is highly desirable for people that must avoid alcohol (e.g., people that are allergic to alcohol, people with alcohol addiction problems, etc.). It should also be appreciated that the above methods and apparatuses can be applied to other suitable fluids in the food and beverage industry.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations have been described. Various modifications may be made without departing from the spirit and scope of the invention. For example, various forms of the flows shown above may be used, with steps re-ordered, added, or removed. Accordingly, other implementations are within the scope of the following claims.

1. A method of separating an organic compound from a fluid, the method comprising steps of:
wetting a nanoporous material with a wetting fluid comprising a first compound;
moving a second fluid across a first side of the nanoporous material for a predetermined quantity of time at a first predetermined rate, wherein the second fluid is in contact with the first side of the nanoporous material and wherein the second fluid comprises at least one second compound;
moving a third fluid across a second side of the nanoporous material for the predetermined quantity of time at a second predetermined rate;
transferring the at least one second compound from the second fluid to the third fluid through the nanoporous material; and
recovering the second fluid with at least a portion of the at least one second compound removed from the second fluid.

2. The method of claim 1, wherein the wetting fluid comprises 20 vol-% or greater of an alcohol.

3. The method of claim 1, wherein the wetting fluid is selected from methanol, ethanol, 1-propanol, 2-propanol, 1-butanol, 2-butanol, 2-methyl-1-propanol (isobutyl alcohol), 2-methyl-2-propanol, 1-pentanol, 3-methyl-1-butanol (isopentyl alcohol), 2,2-dimethyl-1-propanol (neopentyl alcohol), cyclopentanol, 1-hexanol, cyclohexanol, 1-heptanol, 2-heptanol, 1-octanol, 1-nonanol, 1-decanol, phenylmethanol, diphenylmethanol (diphenylcarbinol), and triphenylmethanol (triphenylmethanol), or a combination of any two or more of these.

4. The method of claim 1, wherein the wetting fluid comprises an alcohol having a kinematic viscosity in a range of 0.55 to 15 cP at standard conditions.

5. The method of claim 3 wherein the wetting fluid comprises 2-heptanol or butan-1-ol in an amount of 20 vol-% or more.

6. The method of claim 1, wherein the second compound comprises substantially ethanol.

7. The method of claim 1, wherein the at least one second compound comprises ethanol, and wherein transferring the ethanol from the second fluid to the third fluid through the nanoporous material preferentially permits the ethanol to transfer to the third fluid while substantially excluding water from transferring to the third fluid through the nanoporous material.

8. The method of claim 1, wherein wetting the nanoporous material comprises providing the nanoporous material and the wetting fluid under vacuum and vaporizing the wetting fluid to allow the wetting fluid to contact and condense on the nanoporous material.

9. (canceled)

10. The method of claim 1, wherein a pressure is applied to the second fluid on the first side of the nanoporous material.

11. (canceled)

12. The method of claim 1, wherein the third fluid comprises water.

13. The method of claim 1, wherein moving the second fluid across the first side of the nanoporous material for the predetermined quantity of time at the first predetermined rate further comprises moving the second fluid tangentially across the first side of the nanoporous material.

14. The method of claim 1, wherein moving the third fluid across the second side of the nanoporous material for the predetermined quantity of time at the second predetermined rate further comprises moving the third fluid tangentially across the second side of the nanoporous material.

15. The method of claim 1, wherein the second fluid is moved across the first side of the nanoporous material in a first direction and the third fluid is moved across the second side of the nanoporous material in a second direction, wherein the first direction and the second direction are a same direction.

16. The method of claim 1, wherein the second fluid is moved across the first side of the nanoporous material in a first direction and the third fluid is moved across the second side of the nanoporous material in a second direction, wherein the first direction and the second direction are different directions.

17. The method of claim 1, wherein the nanoporous material comprises a membrane.

18. The method of claim 17, wherein the membrane comprises graphene oxide or molybdenum disulfide.

19. The method of claim 17, wherein the nanoporous material further comprises one or more nanoporous substrates.

20. (canceled)

21. The method of claim 19 wherein the one or more nanoporous substrates comprises a polymer selected from polytetrafluoroethylene, polyethersulphone, polycarbonate, polyvinylidene fluoride, polysulfone, polyvinyl chloride, polyamide, cellulose acetate, nitrocellulose, polyimide, polyacrylonitrile, polypropylene, polyethylene, polyvinyl alcohol, poly(4-methyl-1-pentene), poly(dimethyl siloxane), poly(arylene ether ketone), poly(ether imide), polyethersulfone amide, and combinations or blends of any two or more of these.

22. The method of claim 19 wherein the one or more nanoporous substrate comprises metallic mesh, aluminum, alumina (aluminum oxide), copper, or active carbon.

23. (canceled)

24. The method of claim 1 further comprising:
recovering the third fluid; and
using the recovered third fluid as another wetting fluid for wetting the nanoporous material for separating the organic compound from the fluid.

25-28. (canceled)
